(19) United States
(12) Patent Application Publication
(10) Pub. No.: US 2026/0069503 A1
(43) Pub. Date: Mar. 12, 2026

(54) SYSTEM AND METHOD FOR PRODUCING PHARMACEUTICAL OBJECTS VIA 3D PRINTING

(71) Applicant: PHARMAPRINT LIMITED LLC, Wollerau (CH)

(72) Inventors: Achillefs FREIDERIKOS, Kalithea Athens (GR); Arne-Patrik HEINZE, Hamburg (DE); Konstantinos THEODOSOPOULOS, Exarchia Athens (GR)

(21) Appl. No.: 19/380,472

(22) Filed: Nov. 5, 2025

Related U.S. Application Data
(63) Continuation of application No. 18/067,556, filed on Dec. 16, 2022.

(30) Foreign Application Priority Data
Apr. 19, 2022 (DE) 102022109437.5

(51) Int. Cl. A61J 3/00; B29C 64/165; B29C 64/176; B29C 64/209; B33Y 10/00; B33Y 30/00; B33Y 80/00

(52) U.S. Cl. CPC A61J 3/00; B29C 64/165; B29C 64/176; B29C 64/209; B33Y 10/00; B33Y 30/00; B33Y 80/00

(57) ABSTRACT

Method for 3D printing, comprising the following steps: providing a packaging (2′) having at least one recess (3′) for receiving a product (1′), wherein the shape of the recess (3′) corresponds at least in part to the shape of the product (1′) and wherein the recess (3′) forms a protuberance at the other side of the packaging (2′); providing a 3D printer with a print base (5′) having at least one recess (6′) for receiving the protuberance formed by the recess (3′) of the packaging (2′); inserting the packaging (2′) in the print base (5′) such that the protuberance formed by the recess (3′) of the packaging (2′) is received by the recess (6′) of the print base (5′); filling a print head (7′) of the 3D printer with at least one material for printing the product (1′); 3D printing the product (1′) inside the recess (3′) of the packaging (2′), wherein the part of the recess (3′) corresponding to the shape of the product (1′) serves as the mold and print support, resp., for those layers of the product (1′) which are 3D printed first. The method is performed with a system for 3D printing, comprising a packaging (2′) having at least one recess (3′) for receiving a product (1′), wherein the shape of the recess (3′) corresponds at least in part to the shape of the product (1′) and wherein the recess (3′) forms a protuberance at the other side of the packaging (2′); and a 3D printer with a print head (7′) and a print base (5′); characterized in that the print base (5′) has at least one recess (6′) for receiving the protuberance formed by the recess (3′) of the packaging (2′) to support the packaging (2′) with the recess (3′) such that the product (1′) can be 3D printed inside the recess (3′) of the packaging (2′), wherein the part of the recess (3′) corresponding to the shape of the product (1′) serves as the mold and print support, resp., for those layers of the product (1′) which are 3D printed first.

### CROSS-REFERENCE TO RELATED APPLICATIONS

This is a continuation of U.S. patent application Ser. No. 18/067,556 (filed 16 Dec. 2022), which claims priority to German patent application no. 10 2022 109 437.5 filed 19 Apr. 2022 and is a continuation-in-part of U.S. patent application Ser. No. 16,611,389 (filed 6 Nov. 2019, now U.S. Pat. No. 11,548,221), which was the National Stage of International Application PCT/EP2018/061707 (filed 7 May 2018), which claims priority to Greek patent application no. 20170100219 filed 11 May 2017 and. All subject matter set forth in the above referenced applications is hereby incorporated by reference in its entirety into the present application as if fully set forth herein.

### FIELD OF THE INVENTION

The invention relates to a system and a method for producing pharmaceutical objects via 3D printing.

### BACKGROUND OF THE INVENTION

The invention in particular relates to the art of manufacturing 3D objects by applying, accumulating or creating layers for the creation of 3D printed articles and in particular to a system which is specially modified for the manufacture of multiple tablets, granules, capsules, suppositories, implants and other pharmaceutical items.

The system disclosed in this invention for producing tablets, granules and capsules by means of 3D printing has not been disclosed in the prior art. Until now, 3D printing has in no way been widely applied in the field of pharmaceutics and production of pharmaceutical or non-pharmaceutical tablets, granules or capsules.

Only the WO2017034951 is known in the state of the art, which discloses a 3D printing device and system for the production of pharmaceutical tablets. According to that invention, a powdered mixture is applied on a moving belt, creating the first layer of the tablet before spraying a binding fluid which unifies the mixture and prepares it to receive the next layer. This process is repeated many times resulting in the creation of a solid but particularly porous tablet which is orally dispersible by water.

A major disadvantage of that particular invention is the method of making the tablets, as it is carried out by constantly applying a mixture, a part of which is not used for the preparation of the tablet, resulting in feedstock waste. Furthermore, it is a limiting factor that the device can produce exclusively porous tablets using a powder blend which prevents the manufacture of other types, such as capsules or compact granules, and does not provide for the possibility of printing objects by using a fluid feedstock, the printing process being carried out by continuously applying layers of material in repetitive steps until the formation of the porous tablet.

Most drugs are administered through the digestive tract for the purpose of intestinal absorption, or entry into the bloodstream from the mucosa of the mouth or the mucosa of the rectum. Ingestion of medicaments presents multiple advantages as it is painless and easy, dissolution of the drug is facilitated by abundant digestive secretions, while changes in pH along the digestive tract provide a suitable environment for absorption in virtually all drugs. In addition, great mobility, large surface and abundant blood supply of the digestive mucosa greatly facilitate absorption. The rate of absorption can be varied depending on the tablet formulation, e.g., the ease of disintegration, the solubility of the casing, and/or the size of the granules contained in a capsule. Finally, the relatively slow absorption by the digestive system allows the possibility of early intervention in case of any error.

Although production of drugs administered via the digestive tract shows a number of advantages, production of granules, tablets, capsules and the related pharmaceutical or non-pharmaceutical formulations has been a complex and particularly costly process so far. The costs of research and development of new medicines, the production units, the specialized machinery and materials used to produce medicines, and the increased labour costs contribute to a significant increase in the price of a drug.

A further drawback is due to the high cost of maintaining quantities of medicines for emergencies. Especially in remote and inaccessible areas, the potential emergency leads to the storage of quantities of drugs, which are often left unused until the expiry date.

### SUMMARY OF THE INVENTION

It is therefore an object of the present invention to advantageously overcome the abovementioned drawbacks and deficits of the prior art by proposing a system of production of pharmaceutical objects, such as tablets, granules and capsules, by means of 3D printing.

A further object of the present invention is to provide the proposed system for producing pharmaceutical objects, such as tablets, granules and capsules, by means of 3D printing, for the production of individual prints at the choice of the individual user.

The problem is solved by a system for producing pharmaceutical objects, such as tablets, granules and capsules, via 3D printing comprising a 3D printing machine with a mechanical system movable in one or more directions.

In the context of this invention pharmaceutical objects shall comprise pills, tablets, granules and capsules, suppositories, implants and other pharmaceutical items, which are administered to or placed in a mammal body.

The system further comprises at least one print head with a nozzle being movable by the mechanical system. The system preferably comprises one print head.

The system further comprises a base system carrying a base for receiving a prepared mixture applied by the print head.

The print head perform the action of printing products of this system, by dispensing repeated layers of substance on top of a print base so to form a predefined shape object.

The print head comprises at least one printing nozzle. The nozzle is the part of the print head to allow the flow of material on the print base. They may have or may not have a valve to control flow of substance depending on the characteristics of various fluid substances, such as powders, granules, liquids, gels, creams, pastes etc.

The system further comprises at least one carrier for holding at least one cartridge, wherein the cartridge contains a printable substance. The cartridge may be removed and/or replaced.

The cartridges may each contain one or more of a variety of active substances (API) including—but not limited to—the families of: antibiotics, statins, stimulants, antiseptics, antipyretics, chemotherapeutics, anti-inflammatories, antifungines, hormone medication substances, diuretics, contraceptives, psychotropics (antidepressants, anti-psychotics etc.) etc.

The cartridges may contain one or more of a variety of excipients including—but not limited to—binders, coatings, anti-adherents, colors, flavors, resin, glidants, lubricants, sorbents, vehicles, sweeteners, solvents, inert powders, biodegradable polymers, waxes, preservatives, disintegrants etc.

The cartridges may contain one or more of a variety of substances used in oriental medicine including—but not limited to—herbal pharmacology substances etc.

The cartridges may contain one or more of a variety of substances used in homeopathic medicine including—but not limited to—tinctures etc.

The cartridges may contain one or more of a variety of substances used in bio-engineering medicine including—but not limited to—stem cells etc.

The cartridges may contain one or more of a variety of composite substances created—in any suitable—mixing analogy from any of the aforementioned substance families.

The cartridges may contain a variety of substances that may be still under development or research and not yet disclosed.

It is an advantage of the present invention to provide a system for producing pharmaceutical objects, such as tablets, capsules and granules, by means of 3D printing, which can use cartridges having the corresponding active substance and the corresponding plastic or cohesive substance to be used in 3D printing.

When a cartridge is empty or when another substance is needed the cartridge may be removed from the carrier and a new cartridge may be inserted.

A further advantage of the invention in order to make the present invention useful is to provide systems for producing pharmaceutical objects, such as tablets, capsules and granules, in different sizes and with optionally additional capabilities, covering the simple yet more complex 3D print requirements.

Furthermore, the system may comprise a plurality of carriers for cartridges each containing a different substance for sequential or simultaneous printing of more than one drug at a time.

The carriers may hold a plurality of cartridges with a specific set of printable substances for printing a certain class of pharmaceutical objects. When a pharmaceutical object of a different class shall be printed, the whole plurality of cartridges may be replaced.

In an advantageous embodiment the system has more than one print head.

The mechanical system may comprise a mechanical arm which ends in a print head and which can be moved in one, two or three directions, accurately printing through the head the article required at a time.

A robotic arm is an example of a mechanical arm, usually programmable, with similar functions to a human arm; the arm may be the sum total of the mechanism or may be part of a more complex robot. The links of such a manipulator are connected by joints allowing either rotational motion (such as in an articulated robot) or translational (linear) displacement. The links of the manipulator can be considered to form a kinematic chain. The terminus of the kinematic chain of the manipulator is called the end effector and it is analogous to the human hand.

For the needs of the present system the following types of robotic arms may be used:

Cartesian robot/Gantry robot: Used for pick and place work, application of sealant, assembly operations, handling machine tools and arc welding. It's a robot whose arm has three prismatic joints, whose axes are coincident with a Cartesian coordinator.

Cylindrical robot: Used for assembly operations, handling at machine tools, spot welding, and handling at die-casting machines. It's a robot whose axes form a cylindrical coordinate system.

Spherical robot/Polar robot Used for handling machine tools, spot welding, die-casting, fettling machines, gas welding and arc welding. It's a robot whose axes form a polar coordinate system.

SCARA robot: Used for pick and place work, application of sealant, assembly operations and handling machine tools. This robot features two parallel rotary joints to provide compliance in a plane.

Articulated robot: Used for assembly operations, die-casting, fettling machines, gas welding, arc welding and spray painting. It's a robot whose arm has at least three rotary joints.

Parallel robot: One use is a mobile platform handling cockpit flight simulators. It's a robot whose arms have concurrent prismatic or rotary joints.

Anthropomorphic robot: It is shaped in a way that resembles a human hand, as example with independent fingers and thumbs.

The mechanical system may comprise a scaffold, also called bridge, which is the mechanical structure commonly used in 3d printers. The scaffold consists of structures being vertical and parallel to the ground. The scaffold carries the print head and moves it in an up/down direction and/or in x-direction and/or in y-direction or remains still with the print base doing all the movements necessary.

The system may comprise a fed line for establishing a fluid connection between the carrier and the print head. The printing substance may flow through the fed line from a cartridge in the carrier to the print head. The print line may be flexible such that the carrier may stay at a fixed position while the print head is moved to the printing position by the mechanical system.

Alternatively, the carrier and the print head may be brought closely to each other to establish a direct fluid connection between a cartridge in a carrier and the print head.

Preferably the system comprises a magazine unit with at least one carrier, preferably a plurality of carriers.

In particular at least a part of the magazine unit is moveable, such that the carrier may perform a motion.

For example, by movement of the magazine unit a cartridge being held in one of a plurality of carriers may be transported to a delivery position, where a fluid connection between the cartridge and the print head may be established. After another movement of the magazine unit another cartridge may be moved to the delivery position, such that a plurality of substances may be successively filled in the print head.

The magazine unit may comprise an actuator, in particular a servomotor, a pneumatic drive, a hydraulic drive, a chain drive or a magnetic drive to enable the movement of at least a part of the magazine unit, in particularly to enable the movement of a carriers or of a plurality of carriers.

A plurality of carriers may be arranged on a carousel, such that for moving a single cartridge all carriers have to be moved. A plurality of carriers may alternatively be arranged in line on a guide rail and may be shifted to be brought in a delivery position.

In a preferred embodiment of the system comprises at least one moveable push rod, preferably attached to the carrier, for discharging a cartridge. Hence the cartridges used for the system do not need mechanical equipment for discharging them. A moveable push rod and an actuator for moving the pushrod provide for exact and reproducible dosing an amount of a substance measured according to a selected recipe.

The system may further comprise an opening device, preferably connected with the carrier, for opening a cartridge. For example, the carrier may comprise a needle for punching into a cartridge, a cap remover or a pin for opening a valve of the cartridge.

The system may further comprise a closing device, preferably connected with the carrier, for at least temporarily closing a cartridge during a time when it is not needed for printing.

The system may comprise a reading unit, preferably connected with the carrier, for identifying an identification mark on a cartridge. Hence the system may recognize a kind of substance contained in the cartridge, a use-by date, a target quantity or other data associated with the cartridge.

The reading unit allows logistic support like statistics or automated order for refills. Logistics benefit volume and weight reduction as well as energy consumption needs.

In a preferred embodiment of the system the system comprises a carrier with a temperature control device. The carrier may provide for heating and/or cooling the cartridges.

In a preferred embodiment of the system the system comprises a print head with a temperature control device. The print head may be heatable and/or coolable.

In particular the print head comprises a print head body with indentations, fins or channels for guiding a tempering agent, for example a tempering fluid or a tempering gas, like cooling air. Alternatively, the print head may comprise a thermal conductor which may be heated electrically.

The print head may be covered by a thermal insulation mantle if high temperature is required.

In a preferred embodiment the print head comprises a print head body providing a volume for a printing substance. The print head body may comprise an opening for receiving a fluid substance from a cartridge, which in particular is connectable to a fed line.

Advantageously the print head comprises a stirring and/or discharge tool, in particular a worm screw, being arranged in the printing head body.

The stirring and/or discharge tool may be moveable for example rotatable within a print head body.

A mixing tool provides for mixing a plurality of substances delivered from a plurality of cartridges into the print head.

A discharge tool may provide for discharging a certain amount of substance through the print head during printing. The discharge tool may be a pushing tool, which is moveable in the print head body. The print head may comprise a tool which is suitable for mixing and pushing.

Preferably the system comprises an actuator for moving the stirring and/or pushing tool.

Alternatively, the print head may comprise a discharge tool for reducing the size of the print head body, for example a squeezing tool or a collapsing tool, such that substance is pressed out of the print head nozzle, when the volume of the print head body is reduced.

Preferably the system comprises an actuator for moving the discharge tool.

The print head may comprise a double body: a) an external cylindrical—or other—shape hard body, preferably made from a recyclable material, and b) an inner container made from elastic/flexible/compressible material. On the upper part there could be a plug and on the lower part a cap connected to both bodies and fitted with a printing nozzle possibly fitted with a valve.

It is a further advantage of the invention to provide a system for producing pharmaceutical objects, such as tablets, granules and capsules, by means of 3D printing, which has a pushing tool comprising a punch head to push the proper amount of substance out of the print head at a time in order to print the drug.

In a preferred embodiment the print head comprises a tool which is suitable for mixing and pushing. For this purpose, the stirring tool may be at least partly collapsible, in particular the stirring tool comprises a collapsible head.

The stirring tool with the collapsing head may be made of Kevlar, of carbon fibres or of an epoxy raisin.

The collapsing head may provide for a vacuum effect at the print head nozzle to prevent dripping.

Advantageously the print head comprises a nozzle with a valve, for example a check valve, a shutter valve, a ball valve or a pin valve.

The print head my comprise a spray nozzle and a supply line for compressed air, steam, water, solvents, pharmaceutical inks, alimentary colored inks and more.

The steam could offer bonding to very dry substances, allowing very rapid production rates and very porous finished products. The steam may accelerate pharmacokinetics.

The same may be done with a combination of steam and adhesives and pharmaceutical binders/solvents and water.

Pressurized air could help either drying the items under production, or to be used in the same way as the steam but with pills (etc.) created out of substances that could be affected by heat and/or water.

Colored inks could be used to mark different dosages.

In a beneficial embodiment of the invention the system comprises a thermal print head equipped with a worm screw to stir the mixture prior to 3D printing.

Still another advantage of the invention is the presentation of a collapsible print head which, in addition to stirring, also extracts the air from the mixture, creating more compact tablets, granules or capsules when required.

Advantageously the system comprises an energy emitter, which is linked to the print head. The energy emitter may be arranged on mechanical system and may be moved together with the print head or the energy emitter may be directly attached to the print head. The energy emitter provides for drying or fixing an amount of a substance after it has left the print head nozzle.

In particular the energy emitter is a photopolymer headlamp, an IR emitter, a laser, a microwave emitter, a liquid nitrogen spray nozzle, a compressed air nozzle or a steam nozzle.

The print head may comprise a plurality of nozzles. Hence a plurality of pharmaceutical objects may be printed in parallel.

In an expedient embodiment of the invention the system comprises a cleaning unit for cleaning the print head and/or a cartridge. The cleaning unit may comprise a wash tank and/or a wash port. The wash port may be connectable to a cleaning fluid reservoir and/or a cleaning fluid filtration system.

After usage the print head, preferably together with a stirring and/or pushing tool, may be cleaned, such there is no contamination of the print head when used the next time, with a different recipe.

The cleaning unit may be a special place reserved in the 3d printing system. The cleaning unit may comprise an enclosed area with doors that are necessary for the print heads to be brought in.

These doors, or openings, preferably have all the necessary automation so to be controlled-open-close-lock and monitored as well as every other mechanism inside this area.

The doors or openings preferably have the necessary sealing so to render enclosed area isolated from the rest of the system volume in a way not to compromise vital functions of the system, like the vacuum and the climate control-when these are in use-by evaporation of liquids in use and storage here or by the use of steam. The print head, right after their use is moved here be the mechanical system.

The cleaning unit preferably comprises a heated air supply for drying the print head, nozzles for dispensing steam, compressed air, water and/or solvent spray, a vacuum suction to remove steam and excess liquids, brushes, needles for cleaning very narrow nozzles, valves, breather valves, a tank containing solvents and/or water, in which the print head may be immersed and cleaned, an ultrasound emitter and/or a dedicated cleaning laser emitter.

The tank may comprise a liquid circulation system which may comprise circulators, filters, such as active carbon filters, micro-filters, and dedicated pharmaceutical filters like HEPA H13 filters, and their necessary tubing.

In a preferred embodiment of the invention the system comprises a temperature control system for adjusting the temperature of the print base. The print base system may comprise air ducts or channels for guiding a tempering agent, for example a tempering fluid or a tempering gas, like cooling air.

The temperature of the print base may be adjusted in a range from −5° C. to 40° C. Preferably the print base is heated to assist evaporation and to promote drying of the printed objects.

Advantageously the system comprises a print base comprising formatted printing locations for shaping the pharmaceutical object, in particular convex recesses. The substance may be printed on a receptive formatted printing location, which affects the shape of the pharmaceutical object. The bottom side of the object may for example have a convex shape rather than a flat plain.

Formatted printing locations allow for creating a pharmaceutical object, such as a pill, having a form as the majority of such objects, for example pills, made by traditional means have. They may have a symmetrical lenticular shape.

Also, more complex forms may be created as to assist the immediate visual recognition of the produced items, for example heart shape, rhombus, teddy bear for paediatric use.

The bottom side may also have the shape of the backside of a gummy bear, a Santa Claus, an Easter bunny or any other typical foodstuff form, such that a pharmaceutical object may be printed with the shape of a such a typical foodstuff form.

The print base may have recesses being adapted to accept pill blisters. Usually pill blisters are created by vacuum-formed sheets of a suitable plastic. The pharmaceutical objects can be printed inside a positioned blister. Thus, time may be saved and contact with anything else than the 3D printer's sterile environment is avoided.

According to the present invention, this has been achieved with a method for 3D printing, comprising the following steps: providing a packaging having at least one recess for receiving a product, wherein the shape of the recess corresponds at least in part to the shape of the product and wherein the recess forms a protuberance at the other side of the packaging; providing a 3D printer with a print base having at least one recess for receiving the protuberance formed by the recess of the packaging; inserting the packaging in the print base such that the protuberance formed by the recess of the packaging is received by the recess of the print base; filling a print head of the 3D printer with at least one material for printing the product; 3D printing the product inside the recess of the packaging, wherein the part of the recess corresponding to the shape of the product serves as the mold and print support, resp., for those layers of the product which are 3D printed first. The packaging can be sealed with a cover after the 3D printing of the product is completed.

The object has also been achieved with a system for 3D printing, comprising a packaging having at least one recess for receiving a product, wherein the shape of the recess corresponds at least in part to the shape of the product and wherein the recess forms a protuberance at the other side of the packaging; and a 3D printer with a print head and a print base; characterized in that the print base has at least one recess for receiving the protuberance formed by the recess of the packaging to support the packaging with the recess such that the product can be 3D printed inside the recess of the packaging, wherein the part of the recess corresponding to the shape of the product serves as the mold and print support, resp., for those layers of the product which are 3D printed first. The system can further comprise a mechanism for sealing the packaging with a cover after the 3D printing of the product is completed.

The packaging can be a blister having a plurality of recesses distributed over the blister for receiving products, wherein the shapes of the recesses correspond at least in part to the shapes of the products and wherein the recesses form protuberances at the other side of the packaging; and the print base can have a plurality of recesses for receiving the protuberances formed by the recesses of the packaging, wherein the number and distribution of the recesses in the print base corresponds to the number and distribution of the protuberances formed by the recesses in the packaging.

After the printing is complete, a closing device may apply the sealing membrane or film to hermetically seal the blisters.

A further action could be the labeling of the sealed blisters by a labelling device, such as a laser, being connected to the mechanical system.

The system may comprise a print base comprising a thermal conductor, in particular arranged on the side opposite to a side having formatted printing locations. Hence the print base may be heated directly, for example for drying the printed substance.

The system may comprise a temperature sensor for monitoring the temperature of the print base. The temperature sensor may be a contact sensor or a contactless sensor for example an IR or laser sensor.

The system may comprise a temperature control unit, comprising a temperature sensor, a thermostat and/or a thermal switch.

The print base may be made of metal and/or metal alloys like alclad, a corrosion-resistant aluminum sheet formed from high-purity aluminum with surface layers metallurgically bonded to high-strength aluminum alloy core material), like stainless steel varieties, for example type 310-310S, a highly alloyed austenitic stainless steel used for high temperature application. The high chromium and nickel content give the steel excellent oxidation resistance as well as high strength at high temperature, or type 316 excellent for food and surgical uses,—an alloy addition of molybdenum prevents specific forms of corrosion due to its increased resistance to chloride corrosion) and others.

The print base may be made of plastic and/or composite materials. The print base may be made of tempered glass, such as borosilicate glass, 7740 glass. The print base may comprise ceramics, such as glass-ceramics. Glass-ceramics have the fabrication advantage of glass, as well as special properties of ceramics. They can withstand brazing temperatures up to 700 while maintaining properties like zero porosity, high strength, toughness, low thermal expansion, high temperature stability, machinability, high chemical durability, biocompatibility, isolation capabilities, In manufacturing, glass-ceramics are valued for having the strength of ceramic combined with the hermetic sealing properties of glass.

Preferably the print base has a coating, in particular a ceramic glaze coating. The printed pharmaceutical object may detach from the print base and does not stick to the print base.

Many types of coating may be used, for example: ceramic glaze, an impervious layer or coating of a vitreous substance, which has been fused to a ceramic body through firing, silica nano-coating, silver nano-coating, which is anti-bacterial and anti-fungal, titanium dioxide (TiO₂), nano-particles, which are sterilizing and have anti-fouling properties.

The base system may also comprise an object remover.

The object remover may be formed by a tilt mechanism, which cants the print base, such that the printed pharmaceutical objects slide down the print base to a collection point, for example into a bin.

The object remover may be formed by moveable extractor pins or gas nozzles being connectable to formatted printing locations of the print base. Each printed object may be ejected from the printing location by the pressure of an extractor pin pricking from a hole in a printing location or by the pressure of blow out of a hole in a printing location.

In a preferable embodiment of the invention the base system comprises a base holder for receiving a print base. The print base may be removed and/or replaced.

Print base with different formatted printing locations may be used in the same system. A print base carrying printed object may be removed from the system and replaced by a fresh print base.

In a further beneficial embodiment, the system for 3D printing comprises a mechanical base system capable of moving the print base to one or more directions.

The print base may for example be lifted in a printing level and may be lowered after printing. The print base may also be moved to complete the movement of the mechanical system for moving the print head in order to achieve a full 3D printing also with only a one or two-dimensional movement of the print head.

An advantageous system for 3D printing tablets, granules and capsules has a thermally controlled base with formatted print locations having air ducts for accurately controlling the temperature and humidity of the printed articles.

In a preferred embodiment of the invention the system comprises a chamber, in particular with a door, for establishing a controlled atmosphere. The system is equipped with individual units such as vent filters, ventilation ducts, air filters, an activated carbon filter, an air conditioning system, an air drying system, a vacuum system with a vacuum pump and a head cleaning reservoir.

An advantage of the invention is the ability of the presented system to operate autonomously or in conjunction with a computer to receive orders for 3D printing of granules, tablets and capsules.

The system is preferably controlled by a computer, or a series of computers in order to function. This computer is running on an operational system, for example windows, Linux, IOs etc. and it is provided with all the software necessary to execute its tasks.

The computer preferably controls all of the system's operations and actions. Every subsystem, device and mechanism may be controlled and made to function by a controller. A controller is a comparative device that receives an input signal from a measured process variable, compares this value with that of a predetermined control point value, and determines the appropriate amount of output signal required by the final control element to provide corrective action within a control loop, a PLC, an EPROM etc.

In many cases the same cables connecting each device to the computer can be the power alimentation source for this device (example USB). The computer may be fitted with all the necessary subsystems to interface with the system's user, such as screen (touch, capacitive, LCD or other), an input method (touchscreen, keyboard, multifunction buttons or other), sound and/or visual alert systems, on/off buttons and any other means of interaction system.

The computer may be equipped with the necessary software to accomplish its functions.

The computer preferably comprises the ability to run auto-diagnosis on every sub-system of the mechanism and inform the user of the need to maintain or repair any part of the system or an imminent failure. This way the maintenance cost diminishes and the system's availability increases.

The computer preferably takes care as needed of the calibration of moving mechanisms.

The computer preferably holds the database necessary to select any mixture available and any method suitable to create any product, as well as the form of each product (pill, granule, tablet, suppository etc.).

The computer preferably holds the database of usage statistics and may inform the user of a cartridge containing a particular substance—or mixture of substances—is running low, or even order directly the cartridge needed online streamlining thus the logistics operation.

The database/s necessary for the operations of the system may be stored in the computer's memory and/or at an online position (Internet data storage, remote server, cloud etc.). It may be updated as new products become available (as well as program updates) or can be restored from there if a malfunction occurs.

To achieve this the computer may be provided with a modem (modem, router, etc) connected to the web by cable or wireless technology. Backup of the computer's programs, databases etc. can be provided by flash memory sticks, external hard drives, online data storage etc.

The computer may interact with other devices (external computers, computer accessories like mice, keyboards, web-cams, portable hard-drives, microphones, printers, scanners and speakers tablets, smart-phones, screens etc. by cable (USB, DVI, HDMI etc.) or by wireless technologies.

In the case of small systems (desktop sized or portable) the computer could be external to the system (independent).

All the electronic control subsystems-controllers, regulators and other-may communicate directly (by cable) or indirectly (by the use of bluetooth, WIFI, IR or other) with the use of an interface device (system to computer) comprising the necessary drivers and program/s (or app/s) to install on the computer used.

Power supply may be provided to all subsystems of the system by a module comprising electric power input (cable/s and/or wireless charger), power converter—example 220v/12v—, battery—or battery packs—, UPS {an uninterruptible power supply, also uninterruptible power source, UPS or battery/flywheel backup, is an electrical apparatus that provides emergency power to a load when the input power source or mains power fails}, an auxiliary or emergency power system or standby generator as well as power outputs (USB or other).

The problem is also solved by a method for producing pharmaceutical objects, such as tablets, granules and capsules, via 3D printing, in particular with a system as described above.

The method comprises the following steps.

At least one pharmaceutical substance is provided in at least one cartridge. The cartridge is placed in a carrier. A fluid connection is established between the cartridge and a print head, such that the pharmaceutical substance may leave the print head through the print head nozzle. The print head nozzle is moved according to a 3D print program and the pharmaceutical substance is dispensed to a print base.

The cartridge may be transferred to the print head and may be moved with the print head.

Preferably a quantity of at least one pharmaceutical substance is dosed from the cartridge to the print head, and the substance is stirred in the print head, in particular a plurality of pharmaceutical substances is mixed.

A pharmaceutical fluid composed and mixed according to a specified recipe may be printed.

A plurality of cartridges, each containing a different pharmaceutical substance, may be arranged in a magazine, and the magazine may be moved with respect to the print head to a position, wherein a selected cartridge is fluid connected with the print head. A quantity of a respective pharmaceutical substance may be dosed into the print head, thereby preparing a pharmaceutical mixture according to a pharmaceutical recipe.

In a beneficial embodiment, the system comprises a plurality of print heads, which are moved independently and which each dispense a substance to a print base. A first print head may be filled with a shell or cover substance, another print head may be filled with a first content substance and a further print head may contain a further content substance, such that pharmaceutical objects within an inner structure may be printed.

The method according to the invention is favourable for situations in which regularly individually designed pharmaceutical objects of similar composition have to be provided, such as in hospitals, in nursing homes, in cruise ships, in naval vessels or in refugee camps.

The storing of the matrix substances is easier than storing a stock for each and every implementation of certain pharmaceutical products.

A reduction of packaging with ecological benefit and cost reduction is achieved.

A print base having formatted printing locations may be applied to a print base system before printing. The pharmaceutical substance may be dispensed on the formatted printing locations.

After printing the print head may be cleaned.

Preferably the method comprises the step of providing at least one substance in at least one cartridge, the substance comprising at least one of a fat mass, a starch, a flour, a gelatine, a sweetener, a natural flavour, an artificial flavour and a colorant.

These foodstuff substances ensure that the printed objects are digestible and tasty.

The cartridge may contain also other foodstuff substances that can be used as excipients like emulsifying agents, stabilizing agents, thickening agents, binders, sweetening agents, sugar coating adjuncts, anti-caking agents, emulsifiers, acidulants, acidity regulators, anti-foaming and foaming agents, antioxidants, bulking agents, food colorings, color retention agents, flavors, flavor enhancers, glazing agents, humectants, preservatives, stabilizers, sweeteners etc.

The additional substances may be provided in separate cartridges, such that a compound material containing pharmaceutical substances and foodstuff substances may be mixed in the print head according to a predetermined recipe.

In a preferred embodiment of the method the pharmaceutical substance provided in at least one cartridge comprises at least one of an antipyretic, an analgesic, an antimalarial drug, an antibiotic, an antiseptic, a psychiatric medication, a mood stabilizer, a hormone replacement, an oral contraceptive, a stimulant, a tranquilizer and a statin.

An antipyretic, for example an acetaminophen, reduces fever, pyrexia or pyresis. An analgesic or painkiller, for example acetaminophens, non-steroidal anti-inflammatory drugs or opioids reduces pain. Antimalarial drugs, for example chloroquine and hydroxychloroquine treat malaria. Antibiotics inhibit bacterial growth. Antiseptics prevent germ growth near burns, cuts and wounds. Mood stabilizers are for example lithium and valpromide.

A hormone replacement is for example estrogen or progesterone. Oral contraceptives are for example enovids, “biphasic” pills and “triphasic” pills. Stimulants are for example methylphenidates and amphetamines. Chlorpromazine is an example of antipsycotic medication. Chlordiazepoxide, diazepam, and alprazolam are examples of sedatives and hypnotic medication of the class of Benzodiazepines. Statins are for example lovastatin, pravastatin and simvastatin.

The inventive system and the inventive method may be applied to the formulation of a paracetamol preparation for pediatric use.

Children in the age of 6 to 8 years should ingest 250 mg, children in the age of 8 to 10 years 375 mg, children in the age of 10 to 12 years 500 mg, children in the age of 12 to 15 years 750 mg every 4 to 6 hours.

In an example cocoa butter, cocoa powder, sugar and milk or chocolate mass and a quantity of paracetamol suited to the desired drug to be produced, for example 250 mg of paracetamol are dispensed to the print head, mixed and amalgamated. The print head is heated to reach the temperature for melting the ingredients.

The major factor in not using chocolate and other substances which are appealing to the taste, up to now, was the fact that they could be miss-identified as treats and lead to intoxication due to overconsumption.

By the production of such pharmaceutic objects with a 3d printer capable of dosing precisely this peril is practically eliminated, also due to the fact, that the shape of such tablets can be made easy to distinct them, as well as the extremely small quantities can be produced.

On the other hand, substances as chocolate can facilitate the drugs acceptance by those that usually dislike them.

The production of such a tablet will be used as an example for the function of the 3d printing system function.

The first step is to give the system an input that specifies the product desired, for example a 250 mg paracetamol-chocolate tablet for paediatric use.

The system selects the cartridges containing the ingredients (substances) needed and after sequentially removing their protective caps, fills the print head which has been positioned in the filling position. After that the cartridges nozzles are cleaned by a cleaning device and their caps are repositioned.

The print head is heated at a temperature of 30 to 35 degrees Celsius to assist melting of the excipients, while the mixing mechanism starts to amalgamate the pharmaceutical substance and the excipients.

The print head is positioned over the print base and starts the print procedure according to the dedicated software's commands.

The print base, in turn cools the objects while they are printed so to assist their quick solidification, at a temperature of 20 degrees Celsius. In the same time, the system's airflow and temperature control devices assist the cooling of the tablets under construction.

The procedure ends with the print base delivering the produced items for packaging and the print head and base are thoroughly cleaned and sterilized to be ready for the next system's task.

Further excipients that may be used to obtain the desired taste and texture of the tablets, for example cocoa butter, cocoa powder, sugar, milk, white chocolate, caramel, strawberry flavor, black chocolate and other flavors.

These and other objects, features and advantages of the invention will become apparent in the following detailed description.

### BRIEF DESCRIPTION OF THE DRAWINGS

The invention will become apparent to those skilled in the art with reference to the accompanying drawings in which it is illustrated in an exemplary, non-limiting manner.

FIG. 1 shows a perspective sketch of an illustrative basic embodiment of the 3D printing production system of tablets, granules and capsules;

FIG. 2 shows a perspective sketch of the basic embodiment of the system for producing tablets, granules and capsules by means of 3D printing, with its door open;

FIG. 3 shows a perspective sketch of an exemplary embodiment of the production system, as it is connected to a computer, the dual print head of the system is also displayed;

FIG. 4 illustrates shows a perspective sketch of another exemplary embodiment of the system for producing tablets, granules and capsules by means of 3D printing;

FIG. 5 shows a rear perspective view of the system for producing tablets, granules and capsules by means of 3D printing, where how supply is carried out is also displayed;

FIG. 6 shows in section the embodiment of the tablet, granule and capsule production system by means of 3D printing, also showing the individual components thereof;

FIG. 7 shows in perspective view yet another embodiment of the tablet, granule and capsule production system, via 3D printing, with its door open;

FIG. 8 shows in section the perspective illustration of the above exemplary embodiment of the system;

FIG. 9 shows a sectional front view of the system, where the individual components thereof are shown;

FIG. 10 shows in section the rear view of the system of FIG. 7;

FIG. 11 is a sectional view of the rear view of the above system at a different angle to make visible further details thereof;

FIG. 12 shows, in yet another embodiment, the rear view of the system of FIG. 7;

FIG. 13 shows an exemplary embodiment of the 3D printing system machine equipped with a dual print head and a movable mechanical base;

FIG. 14 shows an alternative embodiment of the 3D printing Machine of the illustrated system, which is capable of continuously delivering a mixture for printing;

FIG. 15 illustrates another alternative embodiment of the 3D printing machine with an arm movable to one or more directions, with a print head and a base movable in one or more directions;

FIG. 16 also shows an alternative embodiment of the 3D printing machine of the illustrated system;

FIG. 17 shows a robotic arm that can be used for the 3D printing of the tablets, granules and capsules through the system of the present invention;

FIG. 18 shows an alternative rack that can be used in the inventive system as 3D printing machine;

FIG. 19 illustrates a partial, longitudinal sectional view of a cartridge used by the present invention for 3D printing of granules, tablets and capsules;

FIG. 20 shows a longitudinal section of a cartridge containing the mixture suitable for each case, while

FIG. 21 illustrates an alternative embodiment of a cartridge with a different tip type;

FIG. 22 illustrates an elongated cartridge carrier which can be used in the present system, together with the punch for propelling the mixture.

FIG. 23 shows a variant of the cartridge carrier, which is rotatable;

FIG. 24 illustrates an alternative embodiment of the system for producing tablets, granules and capsules by means of 3D printing, in section, in which the arrangement of the cartridges and the print heads may be seen.

FIG. 25 shows a thermal print head with support base and accessory carrier and

FIG. 26 shows the rear face of thermal head with its respective cooling fan;

FIG. 27 illustrates a thermal head with a feeding device and a Photo-polymerization headlamp on the head carrier;

FIGS. 28 (a) and (b) show a thermal head and its respective section, in which indentations contributing to heat losses are evident;

FIGS. 29 (a) and (b) illustrate thermal print bases, either with formatted printing locations or of a simple type for printing the articles;

FIG. 30 illustrates a base sectional view with air ducts for air circulation;

FIG. 31 shows a collapsible worm screw that can be used in the production system of the present invention;

FIG. 32 illustrates a perspective view of a worm screw with inlets of active substance and outlets of air, respectively;

FIG. 33 illustrates a sectional view of the base of the collapsible worm screw of FIG. 32;

FIG. 34 shows the collapsible worm screw at a time of full collapse;

FIG. 35 is a cross-sectional view of a multi-print head with worm screw that can be used in the 3D print production system of tablets, granules and capsules of the present invention;

FIG. 36 illustrates a print base with formatted printing locations;

FIG. 37 illustrates an example of a base system;

FIG. 38 illustrates a further example of a base system;

FIG. 39 illustrates a print base with extractor pins (a) in passive position and (b) in an extracting position;

FIG. 40 illustrates an embodiment of a compressible cartridge, (a) in a first position, (b) in a second position and (c) in a third position;

FIG. 41 illustrates cartridge carriers arranged in a magazine unit.

FIG. 42 shows different pills/tablets for ingestion with rounded shapes in perspective and cross-section views.

FIG. 43 shows blisters with a plurality of recesses having round and oval shapes in bottom and top perspective views, resp.

FIG. 44 shows a blister with its flat cover in an exploded top perspective view.

FIG. 45 shows an oval-shaped pill or tablet having three layers in top perspective and cross-section views.

FIG. 46 shows blisters and a print base for receiving them (one blister above the print base and one inserted therein) in a top perspective view.

FIG. 47 shows a cross-section of the print base of FIG. 46.

FIG. 48 shows a print base with one blister inserted therein and a print head filling one of the recesses in the blister in a top perspective view.

FIG. 49 shows a cross-section of FIG. 48.

FIG. 50 shows a close-up of FIG. 49.

FIG. 51A shows a print head filling one of the recesses in a blister in a top perspective view.

FIG. 51B shows a print head filling one of the recesses in a blister in a bottom perspective view.

FIG. 52 shows a blister with one of its recesses filled with a three-layer pill or tablet in a cross-sectional view.

### DETAILED DESCRIPTION OF THE PREFERRED EBMDOIMENTS

Referring now to the accompanying drawings, we will describe exemplary embodiments of the system for producing tablets, granules and capsules by means of 3D printing, in order to make understandable the operation thereof.

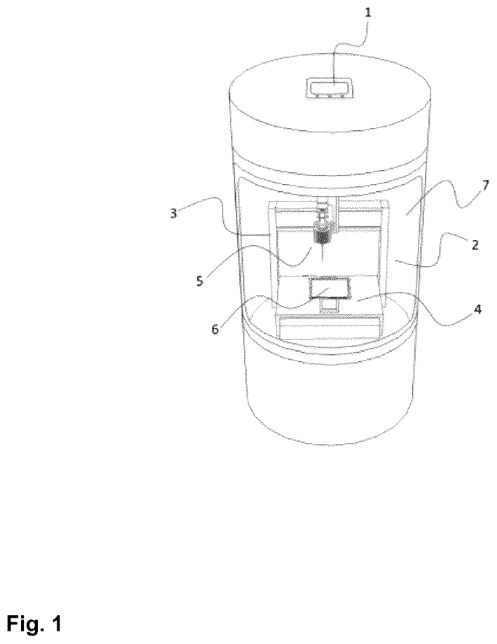

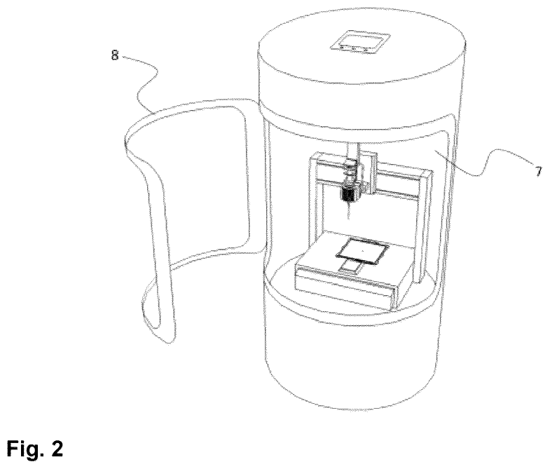

The basic structure of the system is shown in FIG. 1 and comprises a display 1 with keys or touch buttons, from which the user can enter the necessary data and monitor the displayed indications during the system operation. It also comprises a 3D printing machine 2 which has a mechanical system 3 comprising a mechanical arm, movable in one or more directions, a base system 4 which can be fixed or mechanically movable in one or more directions and a print head 5 which dispenses the mixture, depending on the instructions received from software, for the 3D printing of tablets, granules and capsules on the print base 6. The 3D printing machine 2 is located within a chamber 7, which is closed by a door 8, FIG. 2, to create a controlled environment during printing.

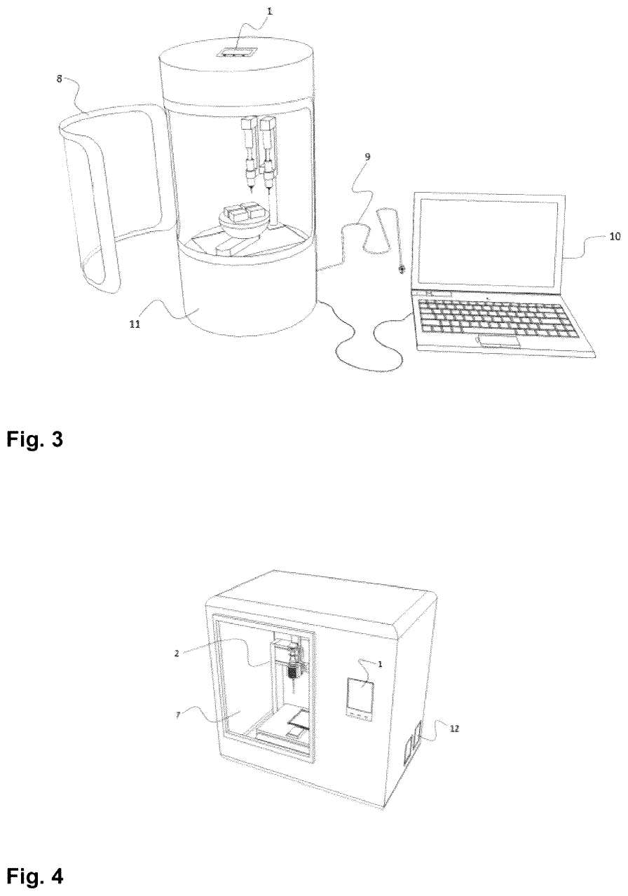

The system for producing tablets, granules and capsules by means of 3D printing of the present invention is further provided with a power cable 9, FIG. 3, and can be connected to a computer 10. This connection can be wired or wireless. However, the system itself may have a built-in computing unit on the base 11 so that no connection to an external computer 10 is required for its operation.

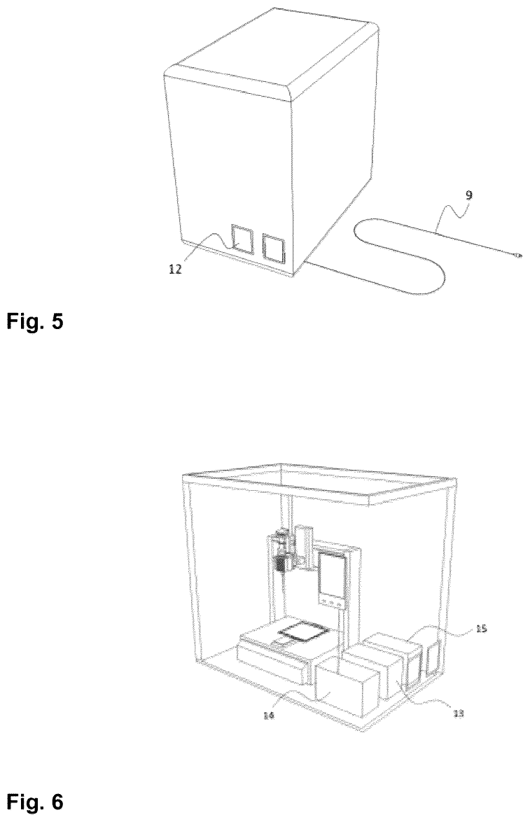

In an alternative embodiment of the invention, the system for producing tablets, granules and capsules by means of 3D printing may be in the form of FIG. 4 similarly including a display 1, a power cable 9, FIG. 5 and a printing chamber 7, in which there is a 3D printing machine 2.

However, it further has one or more ventilation ducts 12 which contribute to the proper circulation of air inside the printing chamber 7. The system is also equipped with an air filter 13, FIG. 6, for cleaning the circulating air, which can be detachable for washing or replacing it when required. A computer unit 14 and a supply unit 15 of the entire system can make it completely autonomous.

In yet another alternative embodiment of the invention, the system for producing tablets, granules and capsules by means of 3D printing, may have additional functional elements making it capable for use in more complex applications.

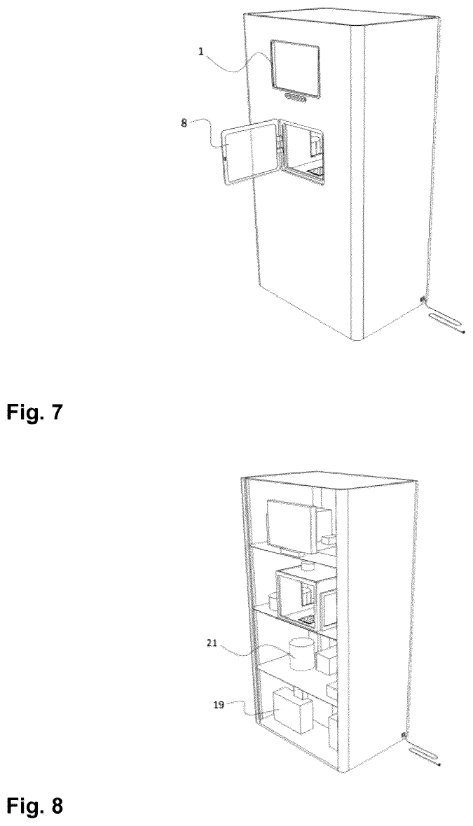

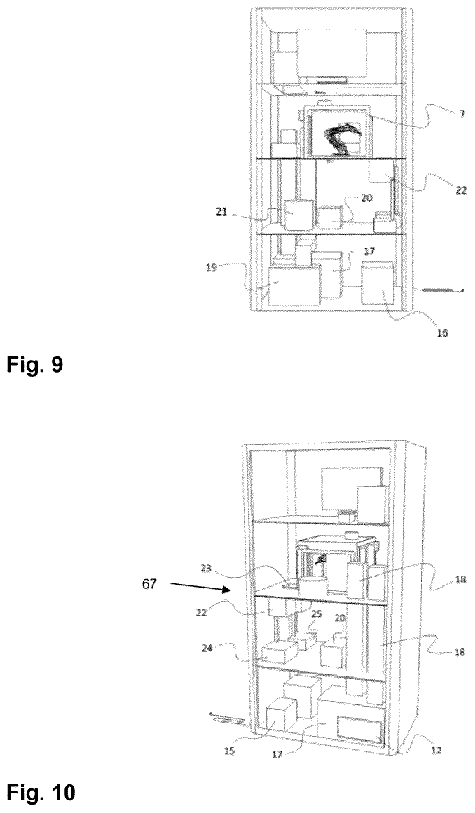

The system has a display 1, FIG. 7, and a door 8 and furthermore has a power supply unit with voltage stabilizer 15, FIG. 10, as well as an uninterruptible power supply 16, FIG. 9, allowing for the uninterrupted operation of the system.

In order to control and maintain the appropriate atmospheric conditions in the printing chamber 7 as well as in the system as a whole, there is an air conditioning and air drying 17 system, while the ventilation ducts 12 allow for the ambient air to enter when this is required. The air conditioning and air drying system 17 is connected by means of one or more air supply and return ducts 18 to the printing chamber 7 and generally to the interior of the system so that when actuating helps in developing the appropriate conditions.

The system also has an activated charcoal filter 19, FIG. 8, for absorbing carbon dioxide and other harmful substances from the circulating air, while a vacuum pump 20 and a negative pressure container 21 contribute to the creation of a vacuum or the appropriate pressure conditions, depending on the requirements.

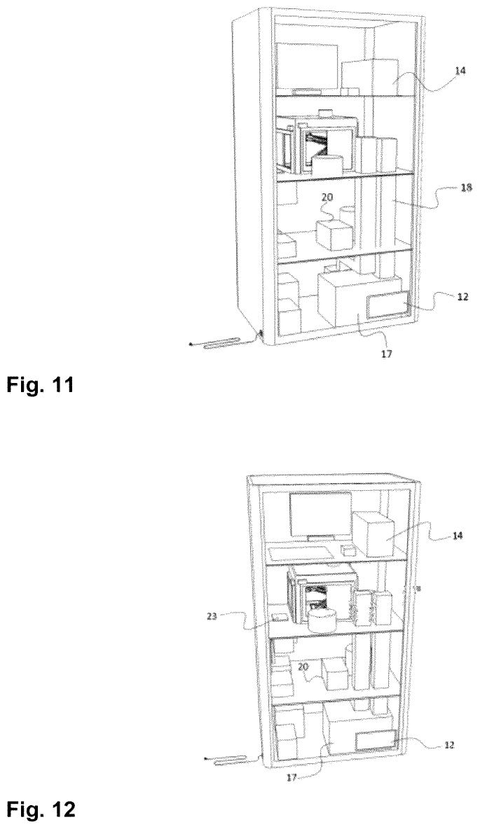

The system may have a cleaning unit 67 comprising a wash tank 22 inside which the print head 5 is washed and cleaned through a wash tank port 23, FIG. 12. In this case, it has a reservoir 24 for the cleaning liquid of the print head 5 and a filtering system 25 for the head cleaning liquid, ensuring that it will be free from any debris after cleaning the print head 5.

The cleaning liquid may be selected from the following examples.

Organic acids, surfactant compounds, corrosion inhibitors, which can be used with precious metals, stainless steel, non-ferrous metals, chromium-plated metal, glass, plastics, semi-precious stones, quartz, ceramics for the removal of lapping pastes, oxide films and annealing colors, for example hydroxyacetic acid.

Acids, solubilizers, wetting agents for removing oxide films from non-ferrous metals with-out corroding metal surfaces and/or for removing lime deposits, for example phosphoric acid.

Alkalines, complexing agents, sequestering agents, solubilizers, surface active compounds, surfactants for removing synthetic resins, mixtures of amorphous resins, polish and abrasive, for example KOH-based or NaOH-based detergents residues, in particular with bactericide and virucidal activity.

Neutral pH cleaner with pH 6-9, for cleaning aluminum and other soft metals, for example NpH sterile or neutral detergents.

The cleaning liquid preferably is phosphate and chlorine-free.

After 3d printing the print head preferably passes pre-filtered drying air which is heated shortly before entering the cleaning unit. The air may be filtered again through a suitable filter, as for example, a HEPA H13 filter is required in Europe. The detergent can be used with ultrasonic or spray technology or as a foam detergent.

The system will have the corresponding computing unit 14, FIG. 11, for processing and executing commands, as previously reported.

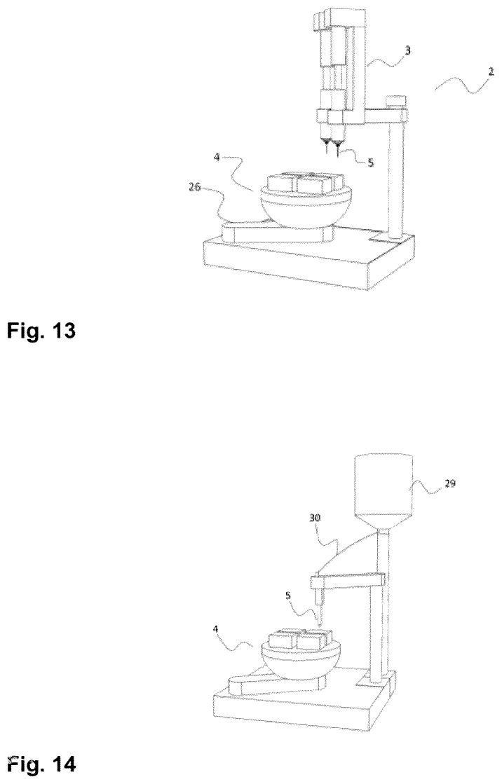

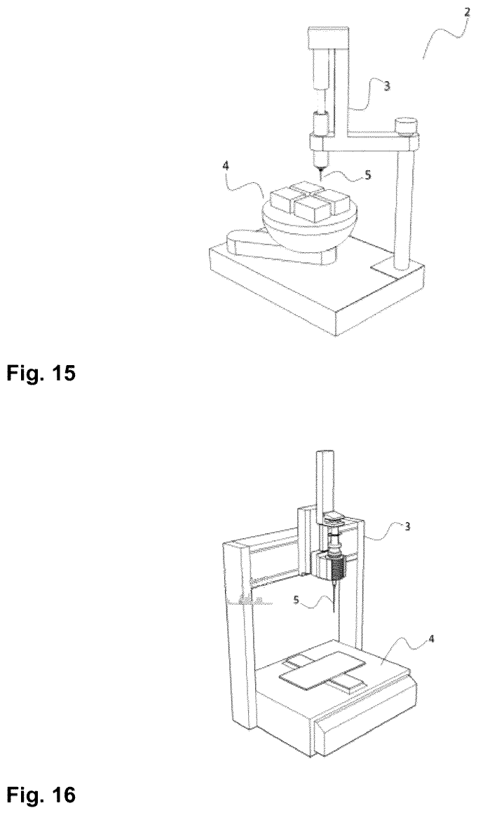

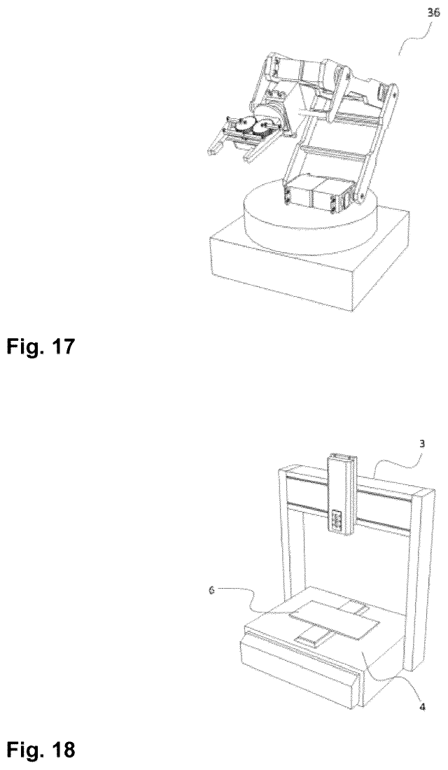

Every system has, as mentioned, a 3D printing machine 2, FIG. 13, which has a mechanical system 3 which ends in one or more print heads 5 for printing on a base system 4. The base system 4 may be fixed or movable in one or more directions, depending on its axis' degrees of freedom 26. Likewise, in alternative embodiments of the invention, the mechanical system 3 may move in one direction, for example up and down, FIG. 15, in two directions, for example up and down and right-left, FIG. 16, or even have a different shape, FIG. 17, possessing more degrees of freedom.

For example, the 3D printing machine 2, FIG. 18, has a base system 4 with a base 6 moving in 2 dimensions and a mechanical system 3, similarly movable in 2 dimensions. 3D printing of tablets, granules and capsules requires one or more mixtures of active substances and substances with plastic (bonding) properties, depending on the finished product to make.

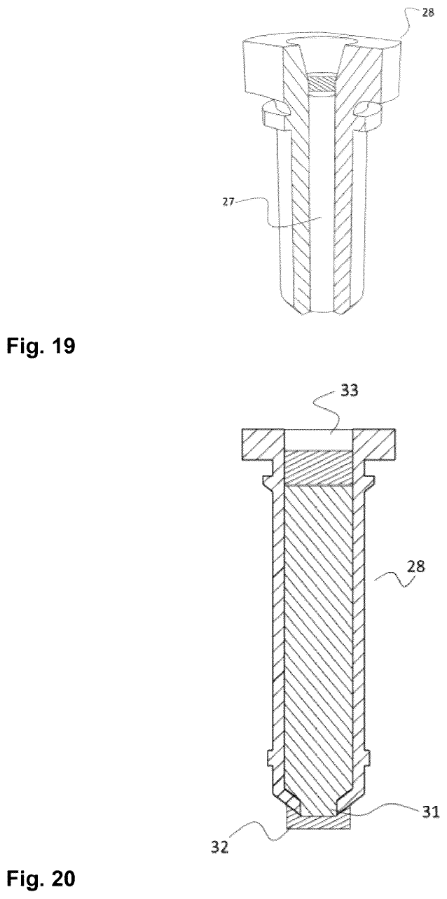

The mixture 27, FIG. 19, which may be exclusively an active substance, exclusively a plastic or a bonding or a combination thereof, may be in liquid form within a cartridge 28, which is fed in the print head 5 or may be constantly provided thereto via a container 29, FIG. 14, which is connected by a fed line 30, for example a dispensing tube, with the print head 5.

The number of containers 29 connected to the print head 5 may be higher than one. Further and alternatively, the cartridge 28 may be permanently attached to the head 5 and singly replaced after it is emptied. In another alternative embodiment the mixture 27 may also have the form of filament.

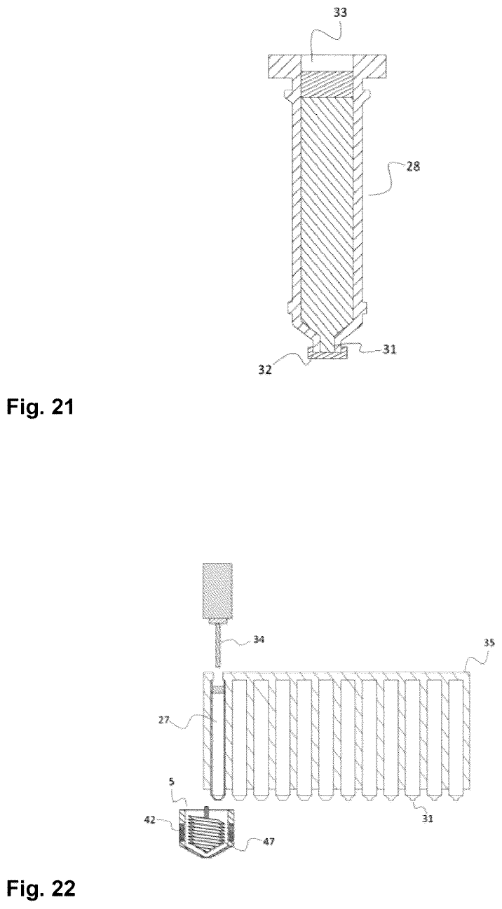

Since the viscosity of the mixtures used varies depending on the manufactured product, the cartridge 28 has different cross-section ends. It may therefore have a wide cross section at the end 31, FIG. 20, or have a narrower cross section, FIG. 21. To close the cartridge 28 underside, a cap 32 may be used, the use of any other appropriate closure whatever not excluded. The upper side of the cartridge 28 has a downwardly movable lid 33 which is urged by a punch 34, FIG. 22, to provide the mixture 27 to the print head 5. The lid 33 may be equipped with a suitable device, such as a radio frequency identification system, to enable the punch 34 to determine its exact location, as well as relevant cartridge information 28.

The cartridges may be provided at their nozzle with a valve to avoid spillage, dry-outs etc. A valve is a device that regulates, directs or controls the flow of a fluid (gases, liquids, fluidized solids, or slurries) by opening, closing, or partially obstructing various passageways. Valves are technically fittings but are usually discussed as a separate category. In an open valve, fluid flows in a direction from higher pressure to lower pressure.

The simplest, and very ancient, valve is simply a freely hinged flap which drops to obstruct fluid (gas or liquid) flow in one direction but is pushed open by flow in the opposite direction. This is called a check valve, as it prevents or “checks” the flow in one direction. Modern control valves may regulate pressure or flow downstream and operate on sophisticated automation systems. These valves may be spring loaded, elastic-made of silicon or other material with similar characteristics of elasticity-having a hole or a cut (straight, cruciform etc) to allow the exit of the material from the cartridge when pressurized by the shaft on the plug. In this case the protective cap of the cartridge's nozzle can be fitted with a small needle. Alternatively, at least one blade may be used in the case of cuts on the valve suited to their form, for example cruciform.

The valve may be of a different type for example a doser-type devise to control the flow if the material included in the cartridge is of a dry (solid) type, such as powders, granules conglomerates etc., or an on/off valve (shutter valves, ball valves, pin valves etc.) for use with liquids. The valves can be pressure inserted at the cartridge nozzle or glued. In the case of solid materials, the valve mechanism may form the lower part of the cartridge itself.

Every system may be equipped with more than one cartridge 28 with the same or different mixture 27 and with the same or different end 31.

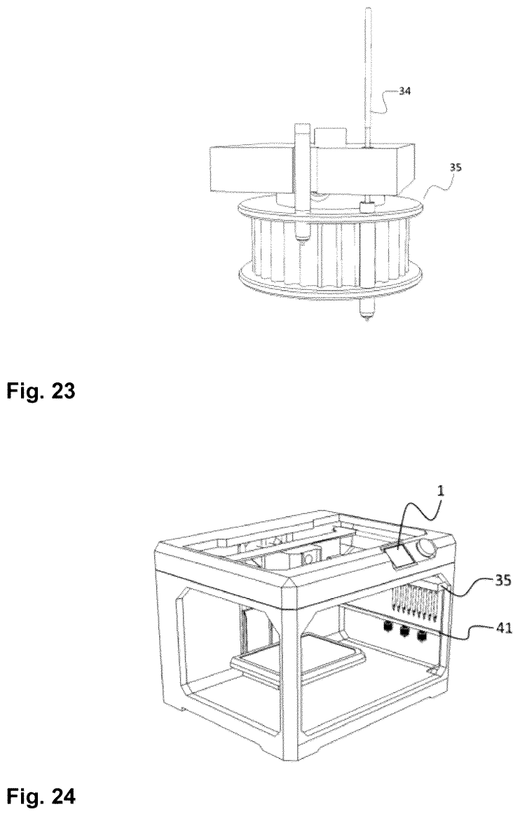

The cartridges 28 are arranged in carriers 35, which may be elongated or even rotatable, FIG. 23. The carriers 35 are mechanically driven by a servomotor or other suitable device, leading the appropriate cartridge 28 into a loading position so that the punch 34 pushes the appropriate amount of mixture 27 into the print head to start the process. The carriers 35 may be located within the 3D printing machine 2, FIG. 24, and led over the base system 4 to start the process or may be firmly positioned at a point from which an arm 36, FIG. 17, receives a cartridge 28 at a time. The size of the carriers 35 and the number of cartridges 28 this may carry is limited only by the available space of the system.

The cartridges may vary in size or shape depending both on the production method. They may be bigger for mass production, for example in a factory, medium sized for pharmacies and hospitals or smaller for desktop or mobile use.

The cartridges as said are preferably created using materials that does not interact or contaminate in any way the included substance (example: oxidation of metal in contact with aqueous or alcohol solvents).

Such materials comprise a vast array of metals like stainless steel, aluminium alloys, and in any case techniques that form a membrane like coating can be used to insulate the contained substance from any metal that could potentially harm it so in theory any metal could be used. As examples of such techniques we could mention: electroplating, spray or dip painting, ceramic coating or even internal extrusion of a suitable plastic membrane.

Such materials comprise a vast array of plastic materials and in this case, care must be given on the avoidance of contamination which may come by reaction (example alcohol solvent and some types of polyethylene plastics) or by release of volatile gases and/or oil substances contained in the plastic itself (example some polyethylene, polyurethane and polyester materials).

In any case a huge variety of plastic materials are available to use such as epoxy, some nylons, polyethylenes and even greater number of composite materials (example nylons with glass micro-spheres created by injection molding or epoxy combined with ceramic micro-spheres).

In the case of plastics, techniques mentioned before may come in use either to further enhance defence of the contained substances or to allow the use of non-suited materials by forming an internal layer of protective material suited for the job (example dual extrusion of PET or PETG and ABS. Such techniques are often used in plastic made, disposable, water and soda bottles). Harder or not-extrudable plastics can be rendered temporarily electro-conductive and thus plated or they may simply be sprayed or dipped to form the protective layer using a suitable material.

In any case glass and ceramics may be used.

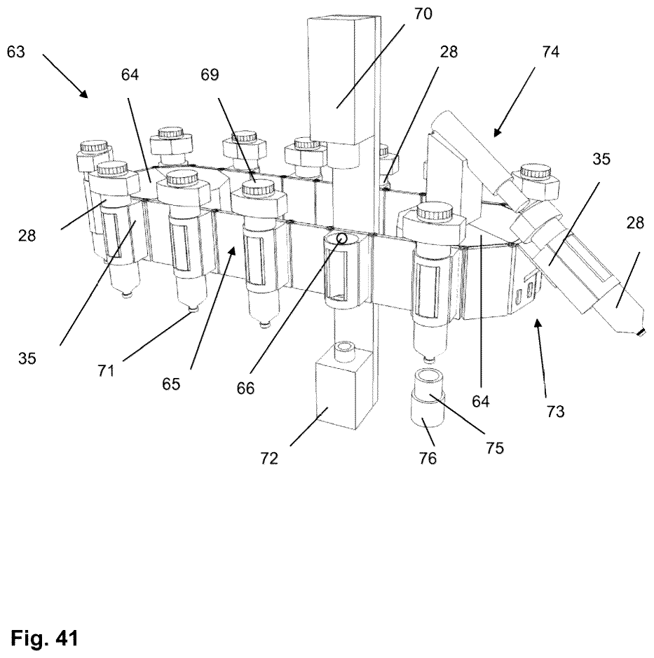

Preferably the cartridges incorporate in their body various methods of identification (RIFD or other chip, barcode or other) which provide an interface with a reading unit 66, see FIG. 41, on the carrier or on a storage container. This info allows the system to recognize the ingredients contained, such that a correct volume may be chosen, or to recognize the shelf-life of each product, the remaining volume in each cartridge, the frequency of use and other. This information can be used as statistics to optimise production and if needed to automate the supply chain by ordering of replacement refills in time.

The print head 5 is the device intended to apply the necessary amount of mixture 27 to produce the corresponding granule, tablet or capsule. The print head 5 is provided with a nozzle 37, FIG. 26, from which the mixture 27 is supplied and a print head body 38, for example formed as a cylinder, with an envelope 39. It further has a support 40, FIG. 28 (a), through which it is held either in a head carrier 41, FIG. 24, or in an arm 36.

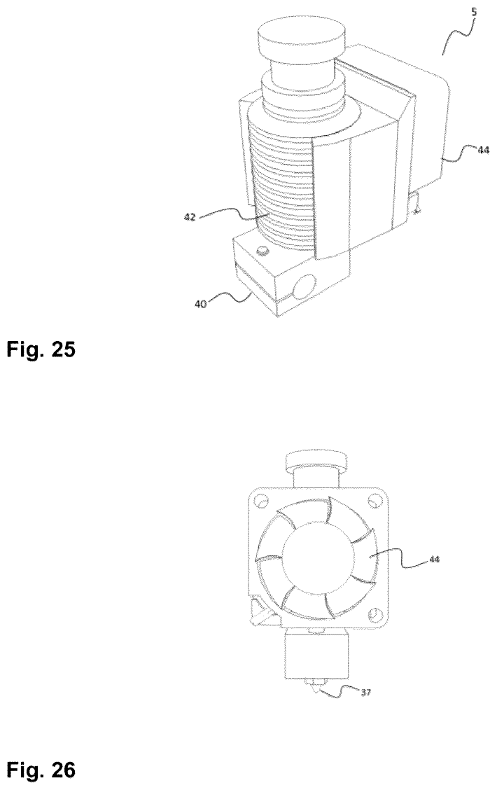

The print head may be a thermal one, FIG. 25, in order to improve the temperature control of the mixture 27. For this purpose, it has a heated body 42 with indentations 43 which contribute to heat losses and can also be provided with a cooling fan 44, FIG. 26, on its rear side, further improving the temperature control.

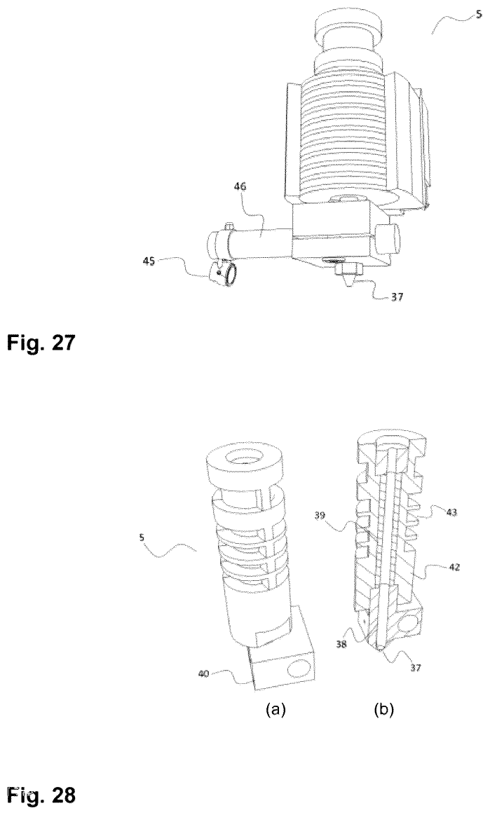

In yet another alternative embodiment, the print head 5 may be provided with an energy emitter 45, in this example a photopolymerization headlamp, FIG. 27, supported on an arm 46, to be used for mixtures 27 requiring its presence.

In another alternative embodiment, the print head 5 may have a liquid nitrogen spray nozzle for direct cooling the printed article.

In an alternate embodiment of the invention, the print head 5 may be provided with a stirring and/or discharge tool 47, in this example a worm screw, FIG. 22, which is rotated continuously or intermittently by means of a servomotor and which shakes the mixture within the print head 5. In this way the mixture 27 will retain the necessary viscosity, depending on the application to be used.

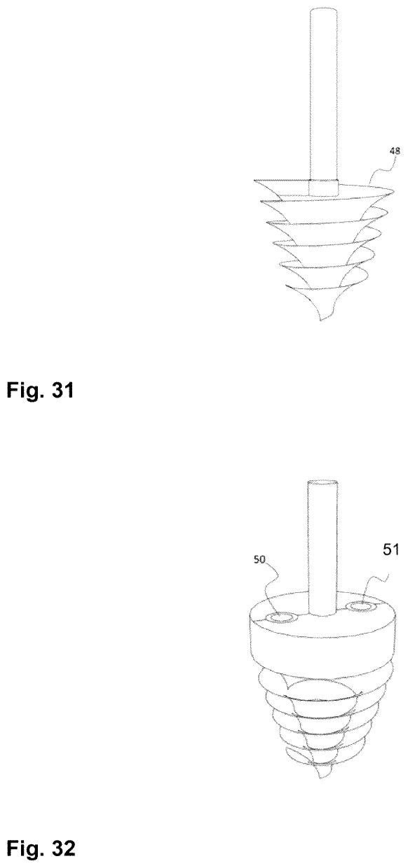

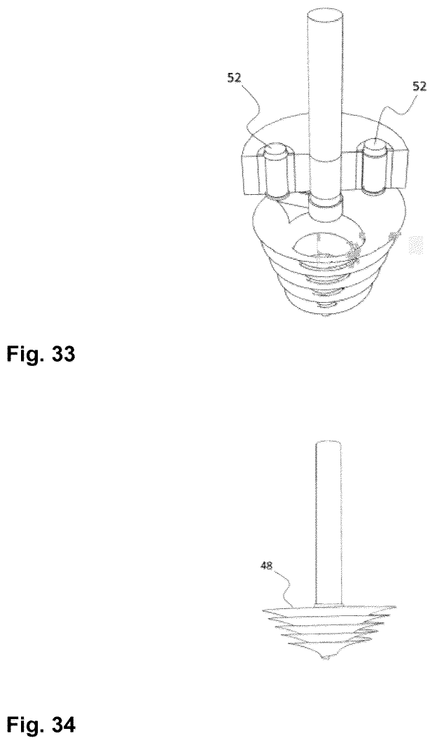

In yet another alternative embodiment of the invention, the worm screw 47 may have a collapsible head 48, FIG. 31, which, in addition to stirring the mixture 27, compresses it appropriately by removing the air. To do this, it has a hole 51 at the top of the head 48, FIG. 32, from which the solvent, the active drug substance or the mixture in general are introduced and a hole 50 from which the air is discharged by compression. The holes can be closed by stoppers 52, FIG. 33 when their use is not required. The collapsible head 48 can be made of stainless steel, thermoplastic materials, and composite materials, such as para-aramid synthetic fibre or memory metals, FIG. 34.

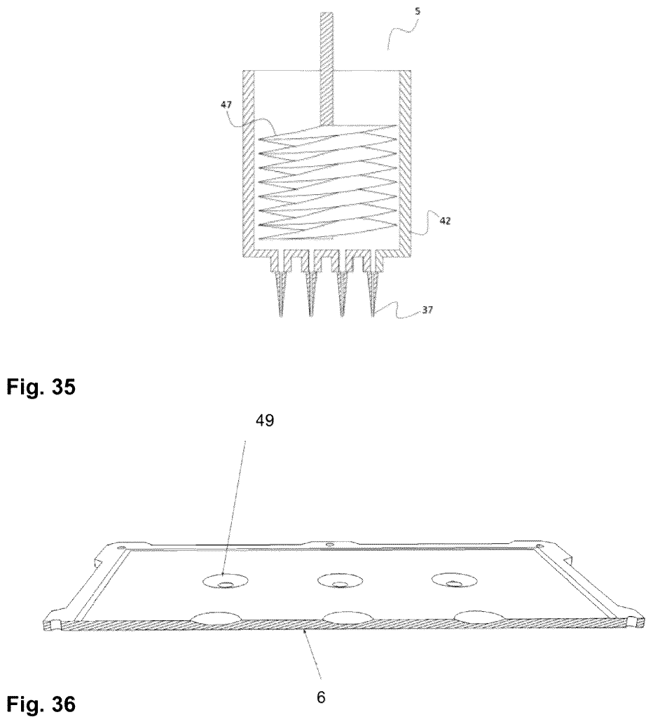

In a further alternative embodiment of the print head (5), this may have both a worm screw 47 with or without a collapsible head 48, with or without a heated body 42 and with more than one nozzle 37, FIG. 35, so that 3D printing takes place at a faster rate.

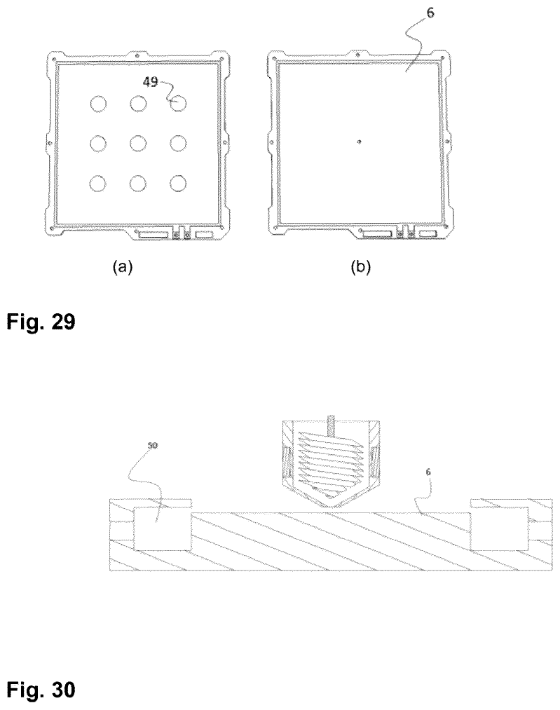

The 3D printing of the tablets, granules and capsules is carried out as mentioned above on a base 6, FIG. 29 (b), which is on the base system 4.

The print base 6 may also be temperature-controlled, and it may also have formatted printing locations 49, FIG. 29 (a) and FIG. 36, for forming the tablet, granule or capsule, by applying the mixture 27.

Upon completion of 3D printing, the articles are removed from the base 6 and the base is repositioned on the base system 4 for later execution of the process. The base 6 may further have air ducts 50, FIG. 30, which allow for natural or forced air flow on the base 6, in order to reduce the evaporation of the moisture content in the produced articles.

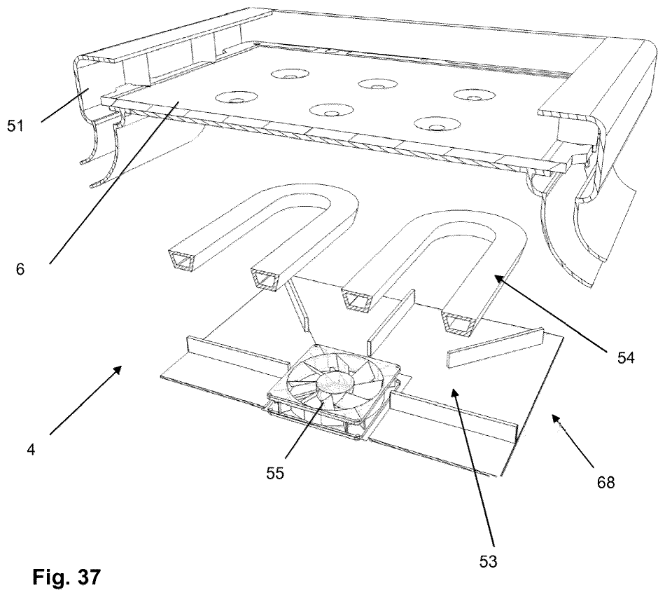

FIG. 37 illustrates an example of a heatable base system 4. The print base system 4 comprises a temperature control system 68 with air ducts 53 and channels 54 for guiding a tempering agent, as well as a fan 55.

The print base 6 is removeably held by a print base holder 57 and may be pushed in and pulled out.

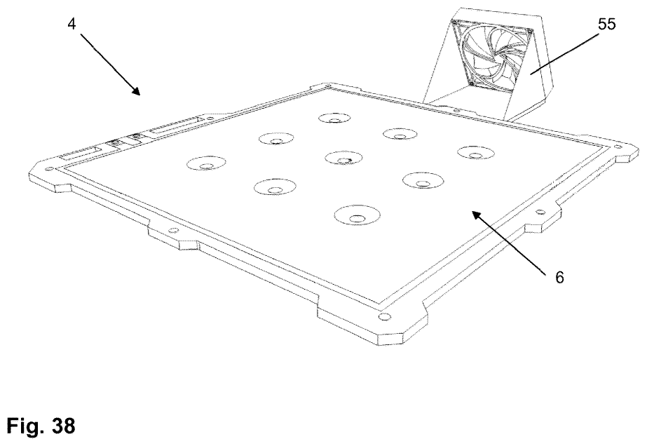

FIG. 38 illustrates a further example of a base system 4, wherein a fan 55 is arranged laterally from the print base 6.

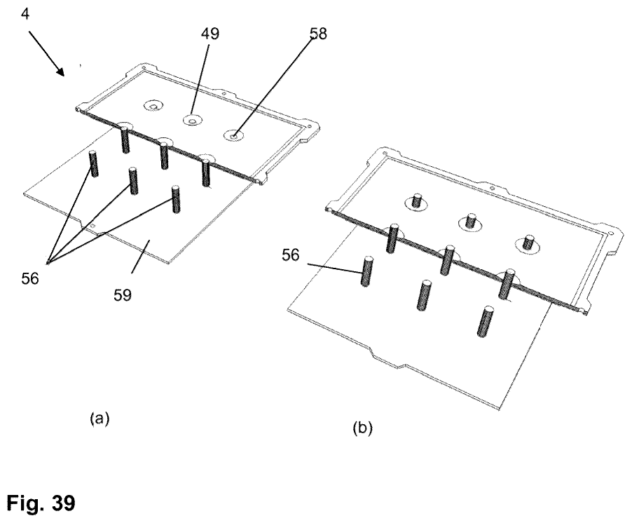

FIG. 39 illustrates base system 4 comprising extractor pins 56. In FIG. 39 (a) the extractor pins 56 are in a passive position, closing holes 58 in the formatted printing locations 49.

The extractor pins 56 are arranged on a plate 59 which may be moved vertically. When the plate is moved upwards, the extractor pins 56 are in an extracting position, FIG. 39 (b). The extractor pins 56 reach out of the holes 58 and may printed matter (not explicitly shown) out of the formatted printing locations 49.

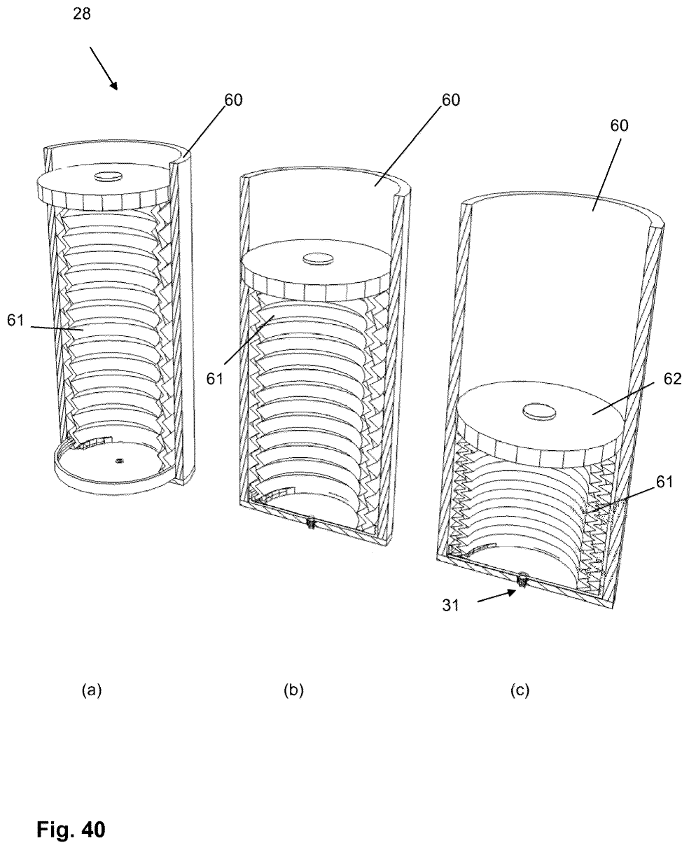

FIG. 40 illustrates an embodiment of a compressible cartridge 28, (a) in a first position, (b) in a second position and (c) in a third position.

The cartridge 28 may comprise a double body: an external cylindrical shape hard body 60 and an inner container 61 made from compressible material. On the upper part there is a plug 62 which may be press downwardly to expel a printing substance (not explicitly shown) out of a lower end 31 of the cartridge 28.

The cartridge 28 may be used as print head, when the cartridge is arranged on the mechanical system and when there is a printing nozzle (not shown) mounted to the lower end 31.

FIG. 41 illustrates cartridge carriers 35 arranged in a magazine unit 63. Each carrier 35 may accept a cartridge 28. The magazine unit 63 comprises rotating actuators 64 and a belt 65 for moving the cartridges 28. Each carrier 35 comprises a reading unit 66 for reading a cartridge 28 identification.

When a cartridge 28 is needed for filling material into the print head (not shown in the figure), the upper cap 69 is removed by an upper-cap remover 70. The carrier 35 being positioned near the upper-cap remover 70 is shown without a cartridge for clarity. Also, the lower cap 71 is removed by a lower-cap remover 72. The cartridge is then moved to a dispensing place 73, where the carrier 35 is tilted together with the cartridge 28. The cartridge is brought into contact with a push rod actuator 74, which presses a defined quantity of material out of the cartridge 28 into the print head.

After dispensing the cartridge 28 may be cleaned in a washing cup 75, which may be lifted by a washing cup actuator 76.

In particular, the present invention can be used to create products by additive manufacturing (3D printing) directly inside their final packaging—in particular pills, tablets and other pharmaceutical or non-pharmaceutical products in a blister—instead of first creating them in a mold such as a powder bed, and then packaging them in an additional step.

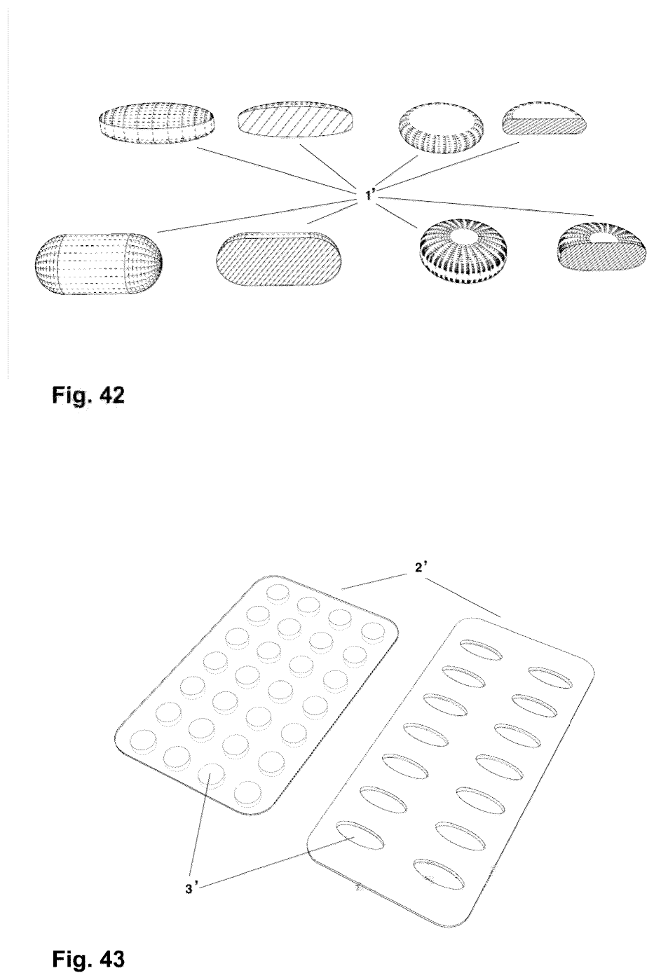

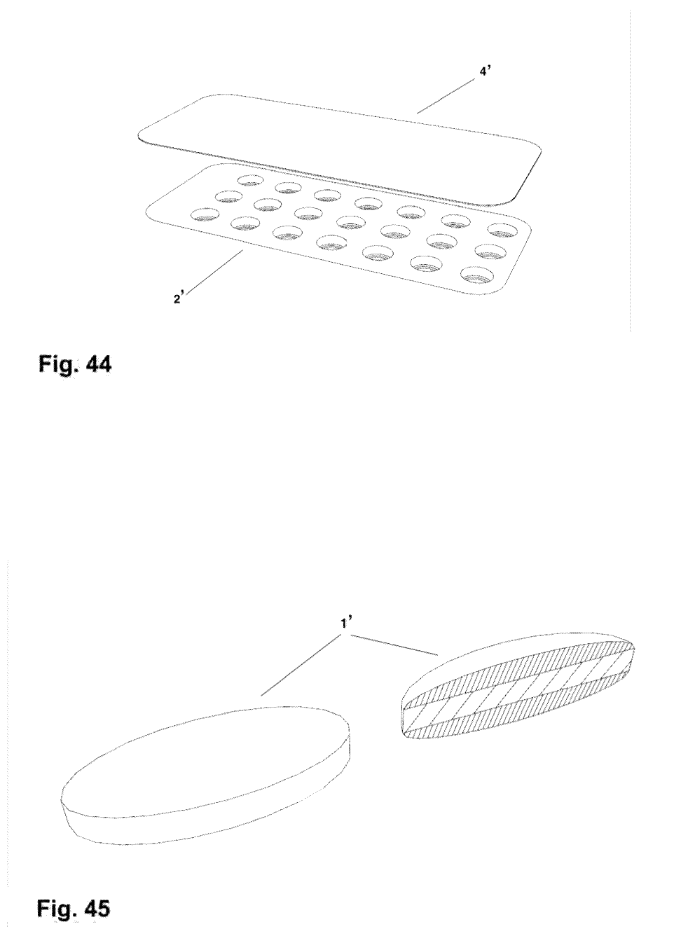

Products such as pills, tablets, suppositories etc. intended for ingestion are normally designed to have a rounded shape—such as a cylindrical, oval or lenticular shape—to present convex surfaces on both sides of their longitudinal axis for facilitating the ingestion itself—FIG. 42 shows different kinds of such pills or tablets 1′ and their cross-sections. If these products are contained in blisters, the latter usually have recesses with a corresponding shape in order to minimize movement of the contained product and so prevent it from being damaged—FIG. 43 shows such blisters 2′ with round and oval recesses 3′. FIG. 44 shows a blister 2′ with a flat cover 4′ it is sealed with after having been filled with the products.

FIG. 45 shows an oval-shaped pill or tablet 1′ having three layers. A convenient method for manufacturing such a pill is additive manufacturing (3D printing). Applicant's WO 2018/206497 A1 discloses a system and method for producing pharmaceutical products via 3D printing. As mentioned before, in the prior art the powder bed technique is often used to be able to create the convex bottom side of the pill or tablet with the powder below acting as the support material. However, as also mentioned above, after having manufactured the product, (i) powder residues on the product have to be removed and (ii) the product has to be packaged, e.g., in a blister.

The method according to the present invention has several advantages over the prior art.

Firstly, both additional steps (i) and (ii) above can be dispensed with by additively manufacturing (3D printing) the tablet or pill directly inside its packaging such as a blister, wherein the shape of the packaging (blister) is selected to correspond at least in part to the shape of the product to be printed such that this part serves as the mold and print support, resp., for the lower part of the pill, tablet etc., wherein “lower part” means the part of the product consisting of those layers of the product which are manufactured first during the additive manufacturing (3D printing) process.

Secondly, the surface quality of a product formed in this way will have a smooth finish due to the packaging (blister) inner surface finish. It is known that any product created by known additive manufacturing shows very distinct lines, corresponding to each layer added and depending on the layer height itself. These lines can vary from being hardly perceivable to very significant. In this connection, it should be noted that, the smaller the layer height, the smoother the finish—but also the longer the time necessary for the 3D printing to complete (as more layers are needed). This problem is avoided if the product is created directly inside its packaging.

Thirdly, the overall additive manufacturing (3D printing) and packaging apparatus is considerably simplified because the same pick-and-place apparatus that places the empty packaging (blisters) on the holders for 3D printing can be used to deliver the sealed full packaging (blisters) to hatches/drawers.

Fourthly, in particular for pharmaceutical products, a secure, i.e., clean and decontaminated, enclosed environment is essential during manufacturing and packaging to avoid, on the one hand, that bacteria, dust, dirt etc. enter from the environment and contaminate the pill or tablet and, on the other hand, that vapors, volatile substances, particles etc. used to create the pill or tablet escape to the environment. If the product is created by additive manufacturing (3D printing) directly into the blister placed on a print base, these costly steps have to be taken only once during manufacturing and not again during separate packaging: An already decontaminated blister or a number of blisters in a magazine and their relative covering films minimizes the times that the aforementioned secure environment has to open, thus eliminating the need of continuous circles of decontamination, and the sealing of the blisters containing the 3D printed products inside this enclosure will ensure that the products will be sealed in a safe and secure environment of their own, until opening the blisters for use (the sealed full blisters can be delivered via a series of alternatively opening hatches or drawers). For the packaging of pharmaceutical products, see the “Guidelines on packaging for pharmaceutical products (Annex 9)” (WHO Technical Report Series No. 902, 2002).

In the following, the method according to the present invention will be explained in detail in connection with pharmaceutical products such as pills or tablets which are manufactured by 3D printing and packaged in blisters. However, it can be applied to any kind of products which are produced by additive manufacturing and then packaged.

### With Additive Manufacturing (3d Printing) As Disclosed,

e.g., in applicant's WO 2018/206497 A1, personalized pharmaceutical products—such as a pill to be replicated several times—can be created according to a specific medical prescription issued by a medical doctor. The prescription states the APIs (Active Pharmaceutical Ingredients) and the desired quantity of each of them, along with other data such as dissolution time and preferred 3D printing method (F.D. M., ink-jet etc., see above). The appropriate form, dimension, composition and manufacturing of the prescribed pill can either be selected from an already existing data base (e.g., at a pharmaceutical company) or entered as a new entry to the data base. (In case of a new prescription, it may be desirable to first get it checked, e.g., at the pharmaceutical company's site, before actually producing it). The corresponding blisters can be created in a quick and easy way by vacuum molding, even in limited series, wherein the blister is selected/created such that it corresponds to the shape of the pill. The blister material must be adapted to the specific 3D printing method used. It is obvious that some 3D printing methods do not require any special blister to be used—apart from keeping the obvious standards for pharmaceutical use—but in other cases, e.g., elevated heat levels may be involved such that a material like aluminum should be used for the blisters.

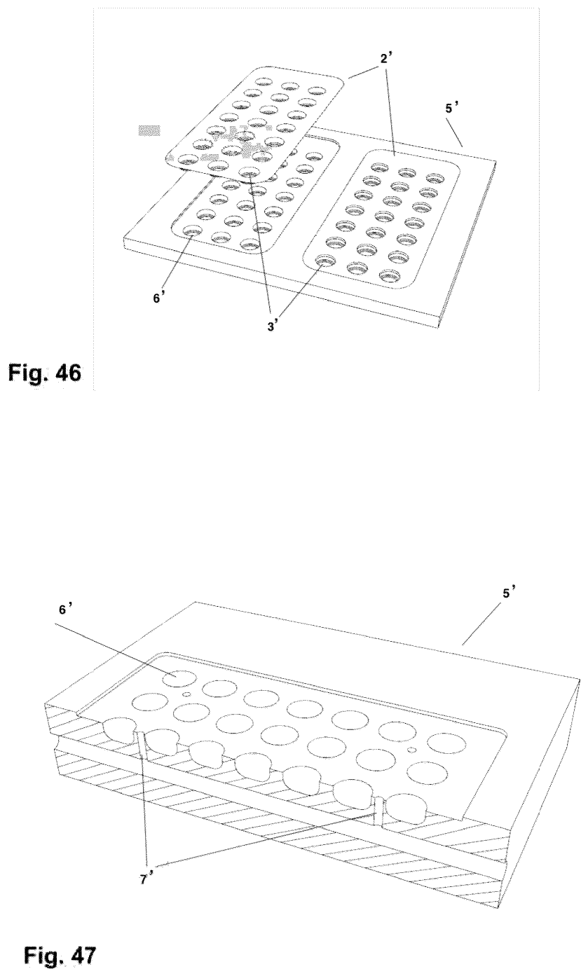

Referring now to FIGS. 46 and 47, in a first step a clean and decontaminated blister 2′ having concave recesses 3′ is inserted in a print base 5′ which is provided with concave recesses 6′ for receiving the convex protuberances (e.g., spherical segments) formed at the other side of the blister 2′ by its recesses 3′. The number and the distribution of the concave recesses 6′ in the print base 5′ correspond to the number and the distribution of the convex protuberances of the blister 2′. Before insertion, the blister 2′ has to be cleaned and decontaminated by the user responsible for the operation of the additive manufacturing device (3D printer). In case the printing takes place in a laboratory or a pharmacy on a small scale 3D printer, this can be a pharmacist who decontaminates the blister and manually inserts it in the print base 5′. In case the 3D printing takes place in a larger scale 3D printing machine comprising an appropriate apparatus such as a pick-and place mechanism with one or more blister magazines (depending on the print shapes available to be created) and the necessary cleaning and decontamination tools (such as UV energy emitters, de-ionized air under pressure, IPA (isopropylic alcohol solution) with distilled water, to name a few), the aforementioned actions performed manually by the pharmacist will be performed in an automated way by the above mentioned apparatuses.

The selected blister 2′ is secured in its position on the print base 5′, as the number and the distribution of the concave recesses 6′ in the print base 5′ correspond to the number and the distribution of the convex protuberances of the blister 2′. Furthermore, the shape of the recesses 6′ in the print base 5′ can either correspond to the shape of the corresponding protuberances formed by the recesses 3′ of an individual blister 2′ (and arranged in corresponding positions), or the recesses 6′ in the print base 5′ can be larger and distributed in such a way that they can receive a number of different blisters 2′ with differently shaped protuberances (cf. FIG. 42). In this example, all recesses 3′ (and their protuberances) in the blister 2′, as well as the recesses 6′ in the print base 5′, have the same shapes. However, there may be other cases when different shapes are desired.

Optionally, the fixation of the blister 2′ on the print base 5′ can by supported by the use of vacuum which is applied through vacuum channels 7′ in the print base, a mechanical clip (not shown) etc. Furthermore, other shapes than spherical segments of the recesses 3′ and 6′ are possible, of course. The print base 5′ can be designed to receive more than one blister 2′ and furthermore be provided with a thermal conditioning mechanism (not shown) which is suitable for facilitating the solidification (hardening) of the product under creation such as a thermal plate, air circulation, a NOX (nitrous) sprayer etc.

After completion of the insertion of the blister 2′ in the print base 5′, this assembly of blister 2′ plus print base 5′ can be considered as a “blister print base” 2′, 5′ for the 3D printing process such that each recess 3′ of the blister 5′ will act as a partial (bottom) mold assisting the forming of the lower part of the specific pharmaceutical product 1′ to be created by additive manufacturing (3D printing).

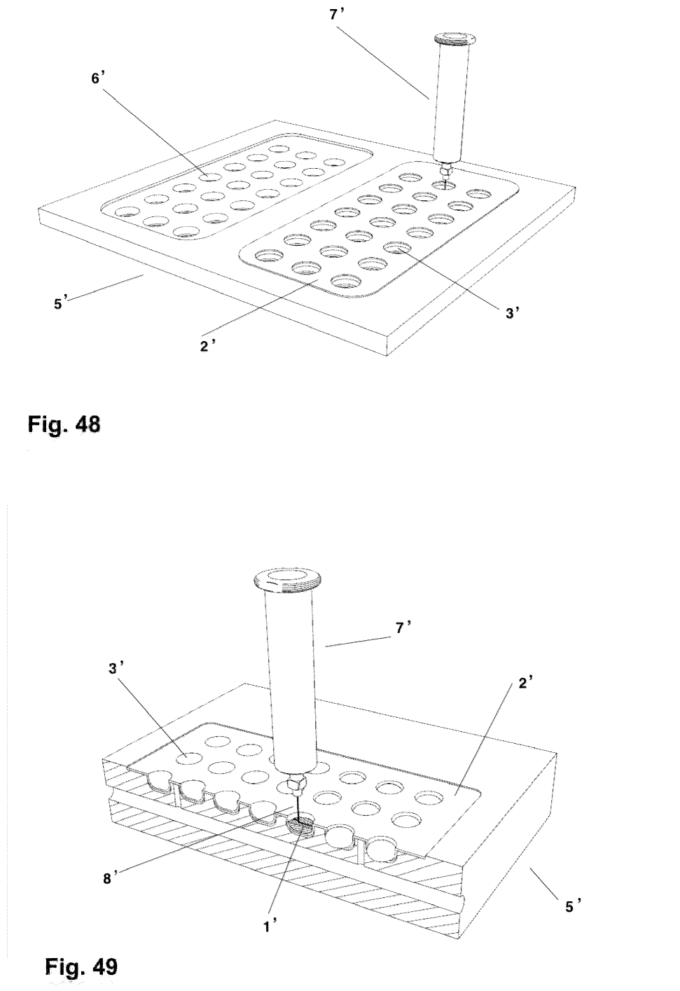

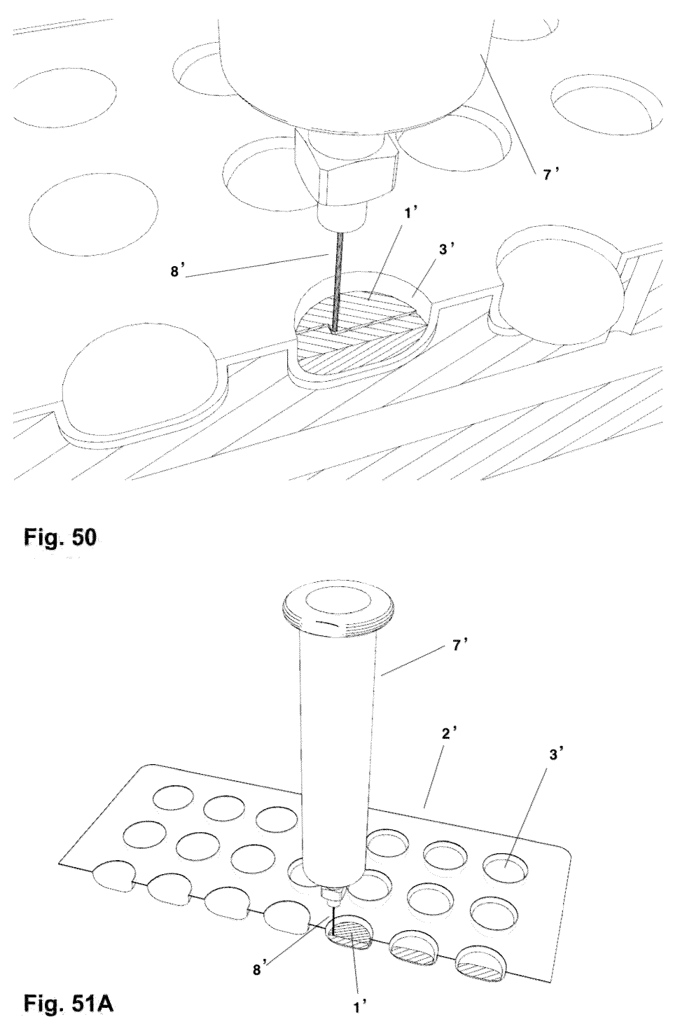

Referring now to FIGS. 48 to 52, in a second step the pharmaceutical product 1′ such as a pill or tablet is created on/in the blister print base 2′, 5′. As mentioned above, the form, dimension, composition and manufacturing of every pharmaceutical product has to be designed and processed adequately—this applies both to single component and multi-component pharmaceutical products (cf. FIG. 45). For example, the quantity of APIs to be used in a specific pharmaceutical product (single or multi-component, according to a specific personalized medicinal recipe) will eventually determine the size and shape to be selected for additive manufacturing (3D printing) and, thus, also the size and shape of the respective blister.

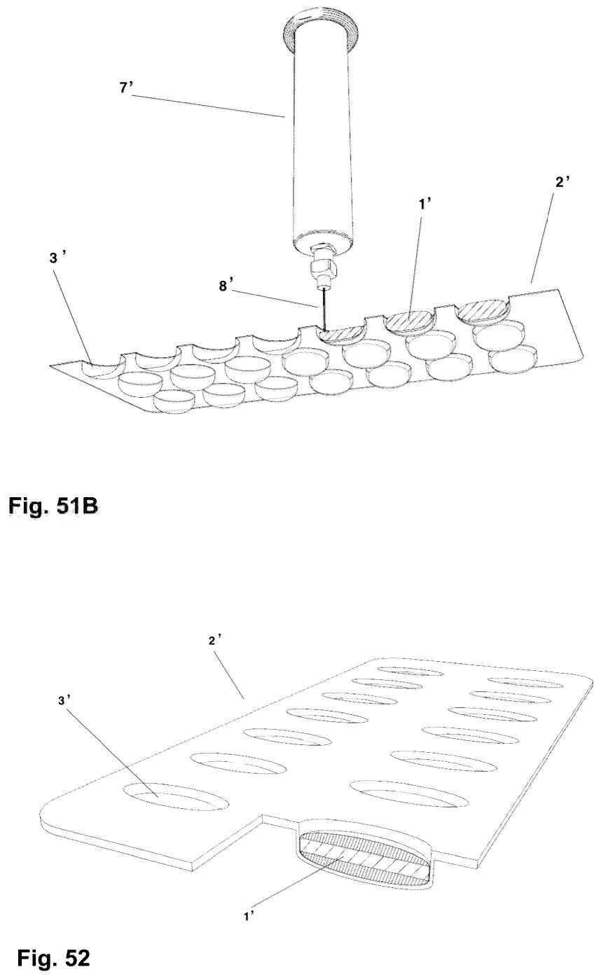

The shape of the recesses 3′ corresponds at least in part to the shape of the pharmaceutical product 1′ to be manufactured such that this part of the recesses 3′ (of the blister 2′ supported by the print base 5′ in its recesses 6′) serves as the mold and print support, resp., for the lower part of the pharmaceutical product 1′, wherein “lower part” means the part of the pharmaceutical product 1′ consisting of those layers which are manufactured first during the additive manufacturing (3D printing) process. Accordingly, the part of the recesses 3′ corresponding to the shape of the pharmaceutical product 1′ is their bottom part. The middle and upper parts of the pharmaceutical product 1′ to be 3D printed will be supported by its lower part and do not necessarily need to be in contact with recesses 3′ (cf. FIG. 51A-52). However, the overall depth/height of the blister recesses 3′ must provide sufficient space between the top part of the finished product 1′ and the top side of the blister 2′ such that the product 1′ will not be damaged during the blister sealing procedure (see step four below).

The appropriate print head 7′ depends on the type of additive manufacturing (3D printing) that is suitable for the specific pharmaceutical product 1′. After the print head 7′ has been filled with the necessary printing material, it is positioned over the blister print base 2′, 5′ and “zeroed”, which means that the precise printing coordinates are fixed in an X-Y-Z axis system such that the printing procedure can take place in the recesses 3′ of the blister. This will vary, of course, for each different shape of pharmaceutical product 1′ and its respective blister 2′ (including, e.g., the precise number of products 1′ to be printed in the respective number of blister recesses 3′), as the movement of the print head 7′ along the X-Y-Z axis system necessary to create the shape of each different product 1′ must coincide with the correct blister recess 3′ shape designed to contain it.

The print head 7′ is provided with a needle-like nozzle 8′ (cf. FIG. 49) which is longer than the depth of the recesses 3′ in the blister 2′, i.e., long enough to reach the bottom of the blister recess 3′ such that the main body of the print head 7′ does not collide with the top part of the blister print base 2′, 5′. In the case of a powder laying method, a powder laying print head can be used, accompanied by an “ink” spray head, wherein the latter should be an ultrathin low pressure spray jet head in order not to interfere with the powder layer already created. The “ink” spray head can either be a separate device or integrated in the principal powder laying print head. When using the powder laying method, a quantity of unused powder may be left in the blister recesses 3′, which should be removed before sealing the blister 2′. This can be done by vacuuming the powder, e.g., with the assistance of a low pressure air nozzle that helps to agitate and detach said powder from the surfaces and the space between the 3D printed products 1′ and the recesses 3′ of the blister 2′. When this operation is performed, a grid or the like can be positioned on top of the blister 2′ containing the 3D printed products 1′ in order to avoid that the latter are sucked off the blister.

The printing process can be performed either completely in each blister recess 3′ such that each product 1′ is finished before the printing of the next one starts, or partially in such a way that the same layer is printed sequentially in all recesses 3′ before another layer is printed (and so on) in order to give teach layer time to solidify. This solidification can optionally be supported by an intermediate external action (air drying, vacuum, UV irradiation etc.), wherein further cleaning and decontamination steps (such as UV irradiation, vacuuming, air circulation, neutral gas enclosed environment, etc.) as disclosed in the applicant's WO 2018/206497 A1 can be continuously applied, if desired.

Before sealing the blisters 2′ (see below), the printed product 1′ can optionally be checked by an electronic visual recognition system (electro optical and/or with FLIR infrared sensor) in order to confirm the integrity of the printed product 1′.

In a third step, the blister 2′ containing the finished product 1′ is sealed with a cover 4′ (cf. FIG. 44). For each type of blister a dedicated sealing film is used, both as far as its form and its material are concerned. The sealing is performed either manually or in an automated way. In case the blister cover 4′ is taken from a continuous roll of film, either a mechanical knife integrated to the heat sealing surface or a low energy carving LASER can be used.

In an optional step following the sealing of the blister 3′, marking procedures can be performed, wherein all necessary information is printed on the cover 4′. Due to the personalized nature of the final product 1′, due care should be taken, as far as the correct marking of each blister is concerned. (The same data can also be printed on a container such as a box, a blistered envelope etc. receiving the finished blisters. Track and trace technology blisters can be used, as well a blockchain system to assure production and distribution safety of the finished product.) The marking step can be followed by a second electro optical check for the integrity of the sealed bister 3′.

In a fourth and final step, the sealed blister 3′ is removed from the print base 5′ either manually or in an automated way.

Although the 3D printed products 1′ should not stick to the (lower) part of the recesses 3′ serving as the mold for the first (lower) part of the products 1′ due to the characteristics of the blister material (such as non-sticky plastics, aluminum etc.), the recesses 3′ of the blister 2′ will be deformed by the user by pushing the protrusion formed by the recess 3′ inside at the moment of removal of the product 1′ (as is the case with every kind of blister packaging in use), which will eventually detach the 3D printed product 1′ from the recess 3′ in case the product 1′ is stuck.

It is clear that the method described above cannot only be used for the additive manufacturing (3D printing) of pharmaceutical products such as pills, tablets etc. but for all kinds of other products such as candies, dish washer tabs etc., wherein the blister can be any kind of packaging which has a shape part of which corresponds to the product to be 3D printed.

It should be noted here that the description of the invention has been made with reference to exemplary, but not limited to, embodiments. Any alteration or modification in shape, dimensions, morphology, materials and components used in manufacturing and assembling, if they are not a new inventive step and do not contribute to the technical development of the already known one, are considered to be within the scope and purpose of the present invention.

### ASPECTS OF THE INVENTION

I. A system for producing tablets, granules and capsules via 3D printing, comprising a display (1), a base (11) with a built-in computer unit (14), a power cable (9), and a 3D printing machine (2) within a chamber (7) with a door (8), with a system of mechanical arm (3) movable in one or more directions, with a base system (4) movable in one or more directions carrying a base (6) and with a print head (5) on the mechanical arm system (3), with a nozzle (37) and a head cylinder (38) with an envelope (39), characterized in that the print head (5) applies on the base (6) a prepared mixture (27) for 3D printing of tablets, granules and capsules.
II. A system for producing tablets, granules and capsules via 3D printing, according to aspect I, characterized in that it has ventilation ducts (12) and an air filter (13) for circulating and purifying the air inside the chamber (7).
III. A system for producing tablets, granules and capsules via 3D printing according to aspect I, characterized in that it has a power supply unit (15) with a voltage stabilizer and an uninterruptible power supply (16).
IV. A system for producing tablets, granules and capsules via 3D printing, according to aspect I, characterized in that it has an air conditioning and air drying (17) system linked via air supply and return ducts (18) with the printing chamber (7).
V. A system for producing tablets, granules and capsules via 3D printing, according to aspect I, characterized in that it has an activated carbon filter (19) for the absorption of carbon dioxide.
VI. A system for producing tablets, granules and capsules via 3D printing, according to aspect I, characterized in that it has a vacuum pump (20) and a negative pressure container (21) for creating vacuum.
VII. A system for producing tablets, granules and capsules via 3D printing, according to aspect I, characterized in that it has a wash tank (22), a wash port (23) connected to a cleaning fluid reservoir (24) and a cleaning fluid filtration system (25) for cleaning the print head (5).
VIII. A system for producing tablets, granules and capsules via 3D printing, according to aspect I, characterized in that the mixture (27) is fed to the print head (5) via the cartridge (28).
IX. A system for producing tablets, granules and capsules via 3D printing, according to aspect I, characterized in that the cartridges (28) are arranged on a carrier (35).
X. A system for producing tablets, granules and capsules via 3D printing, according to aspect I, characterized in that the mixture (27) is fed to the print head (5) via a dispensing tube (30) from the container (29).
XI. A system for producing tablets, granules and capsules via 3D printing, according to aspect I, characterized in that the mixture (27) is in filament form.
XII. A cartridge for use in a system for producing tablets, granules and capsules via 3D printing, according to aspect I, within which a printing mixture (27) is contained and which has an end (31) with a cap (32) and a removable lid (33) on the upper side thereof.
XIII. A print head for use in a system for producing tablets, granules and capsules via 3D printing, according to aspect I, characterized in that it has a heated body (42) with indentations (43) and a cooling fan (44) for controlling the temperature of the mixture (27).
XIV. A print head for use in a system for producing tablets, granules and capsules via 3D printing, according to aspect I, characterized in that it has a photopolymer headlamp (45) on the arm (46).
XV. A print head for use in a system for producing tablets, granules and capsules via 3D printing, according to aspect I, characterized in that it has a liquid nitrogen spray nozzle.
XVI. A print head for use in a system for producing tablets, granules and capsules via 3D printing, according to aspect I, characterized in that it carries a worm screw (47) actuated by a servo motor for stirring the mixture (27).
XVII. A print head for use in a system for producing tablets, granules and capsules via 3D printing, according to aspects I and XV, characterized in that the worm screw (47) has a collapsible head (48) for compressing the mixture (27), with holes (49, 50) intended for entering the solvent and discharging the air, respectively.
XVIII. A print head for use in a system for producing tablets, granules and capsules via 3D printing, according to aspect I, characterized in that it has more than one nozzle (37).
XIX. A print base for use in a 3D printing system according to aspect I, characterized in that it has formatted printing locations (49) for shaping the tablet, granule and capsule.
XX. A print base for use in a 3D printing system according to aspect I, characterized in that it has air ducts (50) for the physical or forced air flow on the base (6).

1. A system for producing pharmaceutical objects comprising tablets, granules and/or capsules, via 3D printing, the system comprising a 3D printing machine with a mechanical system movable in one or more directions, at least one print head with a nozzle being movable by the mechanical system, and a system base carrying a print base for receiving a prepared mixture applied by the print head, wherein the system comprises at least one carrier for holding at least one cartridge containing at least one printable pharmaceutical substance which is filled in the print head, wherein the pharmaceutical substance is a powder, granule, liquid, gel, cream or paste, and wherein
either the at least one cartridge contains more than one of a variety of pharmaceutical substances
or the at least one cartridge contains one of a variety of pharmaceutical substances and at least one other cartridge contains a different pharmaceutical substance,
such that a plurality of pharmaceutical substances is filled in the print head and mixed by a mixing tool to obtain the prepared mixture according to a specified recipe.

2. The system of claim 1, wherein the nozzle comprises a valve to control the flow of the substance depending on the characteristics of the substance.

3. The system of claim 2, wherein the valve is a check valve or an on/off valve.

4. The system of claim 1 comprising a fluid connection between the cartridge and the print head via a feed line or a direct fluid connection between the cartridge and the print head.

5. The system of claim 1, wherein the cartridge has different cross section ends depending on the viscosity of the substance.

6. The system according to claim 5, wherein the cartridge has a wider or narrower cross-section at an end depending on the viscosity of the substance.

7. The system of claim 1, wherein the print base comprises one or more formatted printing locations for shaping the pharmaceutical object.

8. The system of claim 7, wherein the formatted printing locations are convex recesses.

9. The system of claim 7, wherein the formatted printing locations are adapted to receive a blister such that the pharmaceutical objects can be printed directly inside the blister.

10. The system of claim 9, comprising a closing device for applying a sealing membrane or film to hermetically seal the blister after the printing is completed.

11. The system of claim 10, comprising a labeling device for labeling the sealed blister after the sealing is completed.

12. The system of claim 1, wherein the system comprises a reading unit connected with the carrier, for identifying an identification mark on the cartridge.

13. A method for producing pharmaceutical objects comprising tablets, granules and capsules, via 3D printing, the method comprising: providing a system comprising a 3D printing machine with a mechanical system movable in one or more directions, at least one print head with a nozzle being movable by the mechanical system and a base system carrying a print base for receiving a prepared mixture applied by the print head, wherein the system comprises at least one carrier for holding at least one cartridge,
(ii) filling the cartridge with at least one printable pharmaceutical substance, wherein the substance comprises a powder, granule, liquid, gel, cream or paste,
(iii) filling the print head with the at least one pharmaceutical substance from the cartridge and 3D printing the pharmaceutical objects,
wherein
either the at least one cartridge is filled with more than one of a variety of pharmaceutical substances
or the at least one cartridge is filled with one of a variety of pharmaceutical substances and at least one other cartridge is filled with a different pharmaceutical substance
such that a plurality of pharmaceutical substances is filled in the print head and mixed to obtain the prepared mixture according to a specified recipe.

14. The method of claim 13, wherein the print base comprises one or more formatted printing locations adapted to receive a blister such that the pharmaceutical objects can be printed directly inside the blister.

15. The method of claim 14, wherein the system further comprises a closing device for applying a sealing membrane or film such that step is followed by the further step of hermetically sealing the blister.

16. The method of claim 15, wherein the system further comprises a labeling device for labeling the sealed blister such that the step of hermetically sealing the blister is followed by the further step of labeling the sealed blister.

17. The method of claim 13 comprising heating the print base.

18. The method of claim 13 comprising monitoring the temperature of the print base.

19. The method of claim 13 comprising passing pre-filtered drying air through the print head.

20. A non-transitory computer readable medium storing instructions that, when executed by a processor, cause the processor to perform an operation on a 3D printer, the operation comprising:
filling a cartridge with at least one printable pharmaceutical substance, wherein the substance comprises a powder, granule, liquid, gel, cream or paste,
filling a print head with the at least one pharmaceutical substance from the cartridge and
3D printing the pharmaceutical objects,
wherein
either the cartridge is filled with more than one of a variety of pharmaceutical substances
or the cartridge is filled with one of a variety of pharmaceutical substances and at least one other cartridge is filled with a different pharmaceutical substance such that a plurality of pharmaceutical substances is filled in the print head and mixed to obtain the prepared mixture according to a specified recipe.
